(19) United States
(12) Patent Application Publication
(10) Pub. No.: US 2013/0036000 A1
(43) Pub. Date: Feb. 7, 2013

(54) FINANCIAL TRANSACTION SYSTEM AND METHOD

(71) Applicants: Joseph A. Giordano, Waxhaw, NC (US); Yvette Marie Bohanan, San Jose, CA (US)

(72) Inventors: Joseph A. Giordano, Waxhaw, NC (US); Yvette Marie Bohanan, San Jose, CA (US)

(73) Assignee: BANK OF AMERICA CORPORATION, Charlotte, NC (US)

(21) Appl. No.: 13/342,083

(22) Filed: Jan. 1, 2012

Related U.S. Application Data
(60) Provisional application No. 61/514,257, filed on Aug. 2, 2011.

(51) Int. Cl. G06Q 20/10; G06Q 30/02

(52) U.S. Cl. 705/14.27; 705/39

(57) ABSTRACT

Systems, methods, and computer program products are provided for conducting mobile and online financial transactions. Methods include receiving financial transaction instructions, wherein the instructions comprise a first alias and a second alias; associating the first alias with at least one payment account, and the second alias with at least one recipient account; and communicating a financial transaction notification to a recipient associated with the at least one recipient account.

### CROSS-REFERENCE TO RELATED APPLICATION

This application claims priority to U.S. Provisional Patent Application Ser. No. 61/514,257 entitled “Financial Transaction System and Method” filed on Aug. 2, 2011, the contents of which are incorporated herein in their entirety.

### BACKGROUND

With the wide adoption of credits cards, debit cards, electronic payment devices, online shopping systems, and online banking systems, very few people today carry a lot of cash or write many checks. However, people still need to transfer money to each other for all sorts of reasons. For example, a person may want to pay a friend back for money recently borrowed from the friend, or a person may want to send money to a relative as a gift. Giving or lending money to another person, however, can be difficult when you don't have cash on hand and/or if the person is not physically present. The process may need to involve going to an automated teller machine (ATM) or mailing the person a check, both of which can be time consuming and inconvenient depending on the situation.

Money can be transferred from one person to another using electronic banking systems, but these systems traditionally require that the sender know account information for the receiver in order to instruct the bank to transfer money to the proper account. Most people do not know the account numbers of their friends, nor do most people want to widely publicize their account numbers for security reasons. In addition, electronic payment systems also require the purchaser to include a payment account to complete a transaction.

Some third party service providers try to facilitate payments from one person to another, but many people do not like these systems because they require opening yet another account with another online entity, remembering yet another username and password, and disclosing confidential financial institution account information to these other companies. In addition to the inconvenience and the security concerns, these systems generally take time set up and are not user-friendly.

For all these reasons and others, there is a need for improved user-friendly systems and methods for transferring money between two people and/or other entities, especially if such systems can transfer money directly to and/or from financial institution accounts, such as demand deposit accounts (e.g., checking accounts), savings accounts, and/or credit accounts.

### BRIEF SUMMARY

Embodiments of the present invention provide a system and method for conducting financial transactions by associating multiple aliases with multiple accounts using a person-to-person (P2P) and person-to-merchant (P2M) system. Embodiments of the invention enable customers and non-customers of a financial institution to send and/or receive payments at a point of sales device or conduct P2P transfers. Embodiments of the present invention include a P2P and online payment system along with a user-friendly interface and process for sending and receiving payments. Advantageously, embodiments of the invention do not necessarily require user to share confidential information with others in order to send and receive payments. In fact, embodiments of the invention do not require that the payment sender know any information about the financial accounts of the intended payment recipient. Embodiments of the invention also create a “viral” account opening and payment system registration process whereby one person's use of the system encourages others to use the system.

More specifically, embodiments of the invention allow an entity to transfer funds to another entity using a mobile telephone number, electronic mail (email) address, and/or other alias of the transfer recipient. The assignee of the present application describes some embodiments of such an invention in U.S. Provisional Patent Application No. 60/991,172, filed on Nov. 29, 2007, and co-pending U.S. patent application Ser. No. 12/038,177, filed on Feb. 27, 2008, U.S. Provisional Patent Application No. 61/410,085 filed on Nov. 4, 2010, and U.S. Provisional Patent Application No. 64/410,087 filed on Nov. 4, 2010, as well as in U.S. patent application Ser. Nos. 12/881,071, 12/881,073, 12/881,074, and 12/881,080 continuing therefrom; the contents of which are incorporated herein by reference. Embodiments of the present invention include and build off of those earlier embodiments to provide an improved P2P payment system and a more user-friendly, secure, and convenient user interface and method.

Embodiments of the invention also provide a user interface that makes it easy for users to monitor their current, future, pending, and past person-to-person (P2P) and/or person-to-merchant (P2M) funds transfers as well as their saved transfer recipient list, alias registrations, incoming transfers, and/or other related information.

It should be appreciated that at least some embodiments of the invention provide a more convenient, user friendly, and secure P2P payment system because it is provided by the user's bank, through the bank's online banking system with which the user is already familiar. In at least some embodiments, the user may not need to share personal or confidential information, such as account information, with people or businesses outside of the user's bank. The user can feel more secure having P2P payment services handled by their bank and having the convenience of being able to directly send money from and/or receive money into the user's one or more financial institution accounts.

In some embodiments of the invention, a method for conducting financial transactions is provided. The method including: receiving, via a computing device, financial transaction instructions, wherein the payment instructions comprise a first alias and a second alias; associating, via a computing device processor, the first alias with at least one payment account, and the second alias with at least one recipient account; and communicating, via a computing device, a transaction notification to a recipient associated with the at least one recipient account.

In some embodiments of the method, the first alias is associated with a user. In some embodiments, the second alias is associated with a point of sales device. In other embodiments, the first alias comprises a number associated with a mobile device, the number including a random number, or a plurality of aliases associated with a plurality of payment accounts. In some embodiments, the plurality of aliases includes a personal identification number.

In embodiments of the method, the method further includes: determining that the at least one payment account is associated with a third party; and forwarding a transaction notification to the third party. The method further includes, in some embodiments: receiving a payment amount from a user; and transferring a payment to the at least one recipient account. The method further includes: monitoring payment transactions associated with a user; and presenting a transaction history to the user.

In still other embodiments of the method, the method further includes: determining a time period associated with the payment transactions; and grouping the payment transactions into categories based on the time period. In other embodiments, the method further includes: identifying a loyalty card associated with the user; determining rewards associated with the loyalty card; and presenting the rewards to the user.

In embodiments of the invention, a computer program product is provided. The computer program product includes a computer-readable medium having computer-executable instructions for performing: receiving financial transaction instructions, wherein the instructions comprise a first alias and a second alias; associating the first alias with at least one payment account, and the second alias with at least one recipient account; and communicating a financial transaction notification to a recipient associated with the at least one recipient account.

In embodiments of the invention, a system for conducting financial transactions is provided. The system includes: a computer apparatus including a processor and a memory; and a payment module stored in the memory, executable by the processor and configured to: receive payment instructions, wherein the payment instructions comprise a first alias and a second alias; associate the first alias with at least one payment account, and the second alias with at least one recipient account; and communicate a payment notification to a recipient associated with the at least one recipient account.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C are flowcharts of a system and method for making payments in accordance with various embodiments of the invention.

FIG. 2 is a combination flowchart and block diagram of a system and method for making P2P payments in accordance with example embodiment of the invention;

FIG. 3 is a block diagram illustrating the various ways through which a customer may make P2P payments in accordance with various embodiments of the invention;

FIG. 4 provides a block diagram illustrating an online banking P2P payment system and environment in accordance with an embodiment of the invention;

FIG. 5 provides a block diagram illustrating the merchant's computing device of FIG. 4, in accordance with an embodiment of the invention;

FIG. 6 provides a block diagram illustrating the user's personal computing device of FIG. 4, in accordance with an embodiment of the invention;

FIG. 7 provides a block diagram illustrating the financial institution's online banking system of FIG. 4, in accordance with an embodiment of the invention;

FIG. 8 provides a block diagram illustrating the alias data repository of FIG. 4, in accordance with an embodiment of the invention;

FIGS. 9A-9F provide flow charts illustrating a process for making P2P payments, in accordance with embodiments of the invention;

FIGS. 10A-10I provide screenshots of a graphical user interface used during the process described in FIGS. 9A-9F, in accordance with embodiments of the invention;

FIGS. 11A-11C provide flow charts illustrating a process for receiving P2P payments, in accordance with embodiments of the invention;

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “financial institution” or “financial entity” include any organization that processes financial transactions including, but not limited to, banks, credit unions, savings and loan associations, investment companies, stock brokerages, asset management firms, insurance companies and the like. In specific embodiments of the invention, use of the term “bank,” is limited to a financial entity in which account-bearing customers conduct financial transactions, such as account deposits, withdrawals, transfers and the like.

Embodiments of the present invention provide a system and method for conducting financial transactions by associating multiple aliases with multiple accounts using a mobile and/or banking online system. Embodiments of the invention enable secure P2P or point of sales transactions for customers and non-customers of a financial institution. Further, embodiments of the invention allow users to make payments directly from their accounts, whether their accounts be checking, savings, line of credit, credit card, and/or other accounts, to a payment recipient (e.g., the merchant), including financial entity customers and non-financial entity customers, without having to share any confidential account information and without having to know account information for the intended payment recipient. Embodiments of the invention also allow users to receive payments from others directly into their financial institution accounts without requiring the user to share account information with the payment sender. It should be noted that some embodiments of the invention allow a customer to make payments to and/or receive payments from a merchant in the same way that a customer can make payments to and/or receive payments from another person. As such, as used herein, the phrase person-to-person (P2P) is intended to include person-to-merchant (P2M), merchant-to-merchant (M2M), and merchant-to-person (M2P) unless specifically stated otherwise. The merchants include small businesses, independent businesses, home offices, as well as large and well established businesses. Moreover, embodiments of the present invention permit a sender to send money from the sender's financial institution account directly to the recipient's financial institution account using the alias of the recipient with or without the involvement of an intermediary or a third party.

Embodiments of the invention include systems and methods for conducting financial transactions. Examples of conducting financial transactions include push payments, money transfers between individuals, online transactions, and the like. Financial transactions includes payments, money transfers, purchases, gifts, credits, withdrawals, deposits, or any other type of financial transaction or combination of transactions. Systems and methods for making payments are described below, but it will be understood that the systems and methods include any type of financial transaction.

In some embodiments, the transaction may refer to an event and/or action or group of actions facilitated or performed by a user's device, such as a user's mobile device. Such a device may be referred to herein as a “point of sales device”. A “point of sales” could refer to any location, virtual location or otherwise proximate occurrence of a transaction. A “point of sale device” may refer to any device used to perform a transaction, either from the user's perspective, the merchant's perspective or both. In some embodiments, the point of sale device refers only to a user's device, in other embodiments it refers only to a merchant device, and in yet other embodiments, it refers to both a user device and a merchant device interacting to perform a transaction. For example, in one embodiment, the point of sales device refers to the user's mobile device configured to communicate with a merchant's point of sale terminal, whereas in other embodiments, the point of sales device refers to the merchant's point of sale terminal configured to communicate with a user's mobile device, and in yet other embodiments, the point of sales device refers to both the user's mobile device and the merchant's point of sale terminal configured to communicate with each other to carry out a transaction.

In some embodiments, a point of sales device is or includes an interactive computer terminal that is configured to initiate, perform, complete, and/or facilitate one or more transactions. A point of sales device could be or include any device that a user may use to perform a transaction with an entity, such as, but not limited to, an ATM, a loyalty device such as a rewards card, loyalty card or other loyalty device, a magnetic-based payment device (e.g., a credit card, debit card, and the like), a personal identification number (PIN) payment device, a contactless payment device (e.g., a key fob), a radio frequency identification device (RFID) and the like, a computer, (e.g., a personal computer, tablet computer, desktop computer, server, laptop, and the like), a mobile device (e.g., a smartphone, cellular phone, personal digital assistant (PDA) device, MP3 device, personal GPS device, and the like), a merchant terminal, a self-service machine (e.g., vending machine, self-checkout machine, and the like), a public and/or business kiosk (e.g., an Internet kiosk, ticketing kiosk, bill pay kiosk, and the like), a gaming device, and/or various combinations of the foregoing.

In some embodiments, a point of sales device is operated in a public place (e.g., on a street corner, at the doorstep of a private residence, in an open market, at a public rest stop, and the like). In other embodiments, the point of sales device is additionally or alternatively operated in a place of business (e.g., in a retail store, post office, banking center, grocery store, factory floor, and the like). In accordance with some embodiments, the point of sales device is not owned by the user of the point of sales device. Rather, in some embodiments, the point of sales device is owned by a mobile business operator or a point-of-transaction operator (e.g., merchant, vendor, salesperson, and the like). In yet other embodiments, the point of sales device is owned by the financial institution offering the point of sales device providing functionality in accordance with embodiments of the invention described herein.

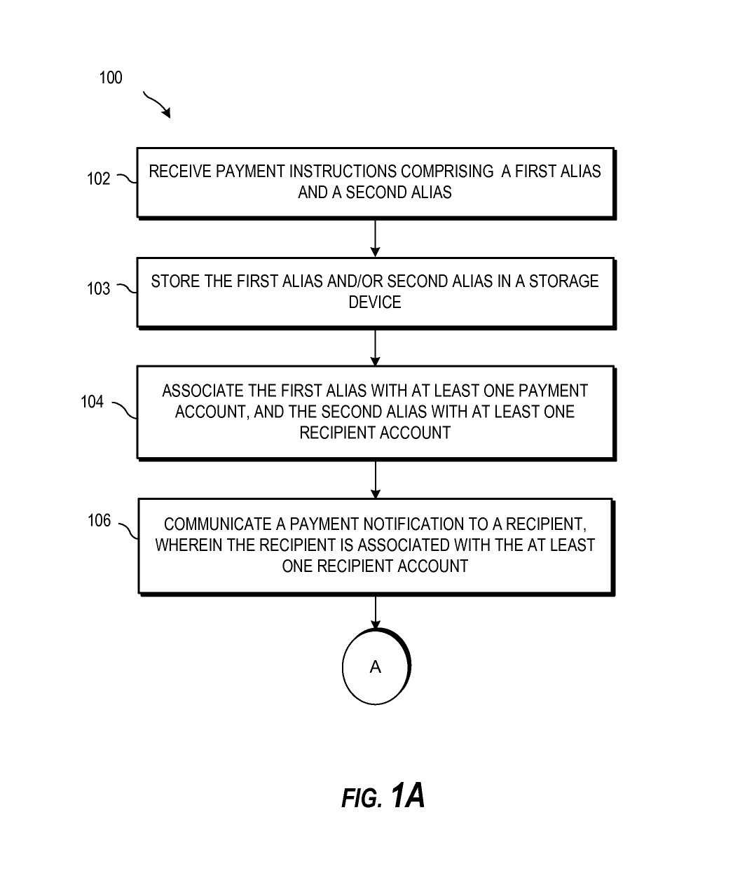

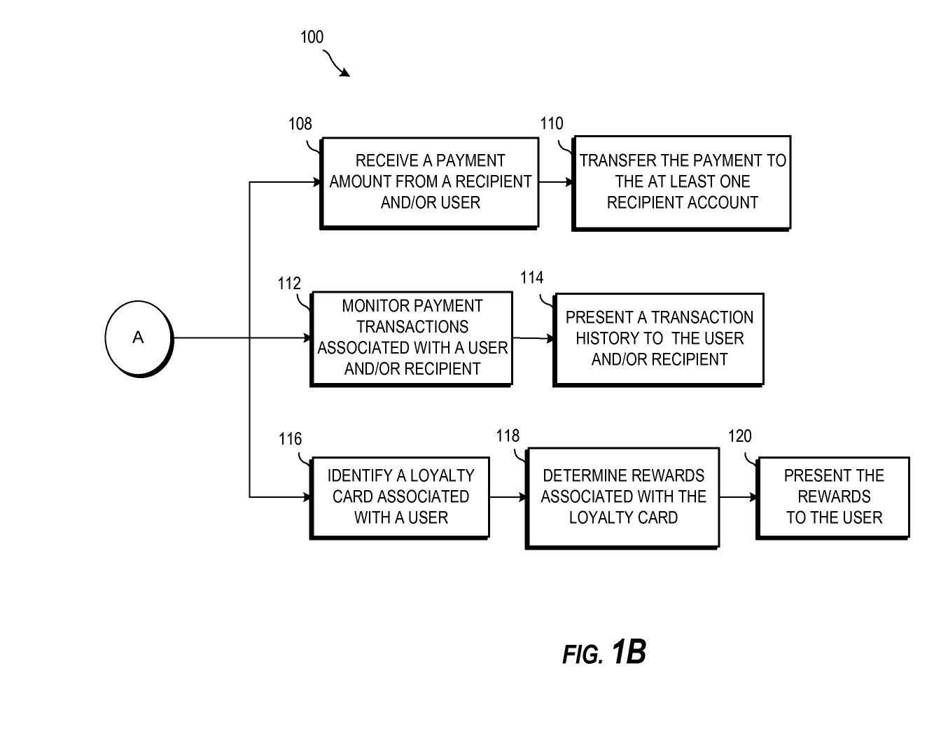

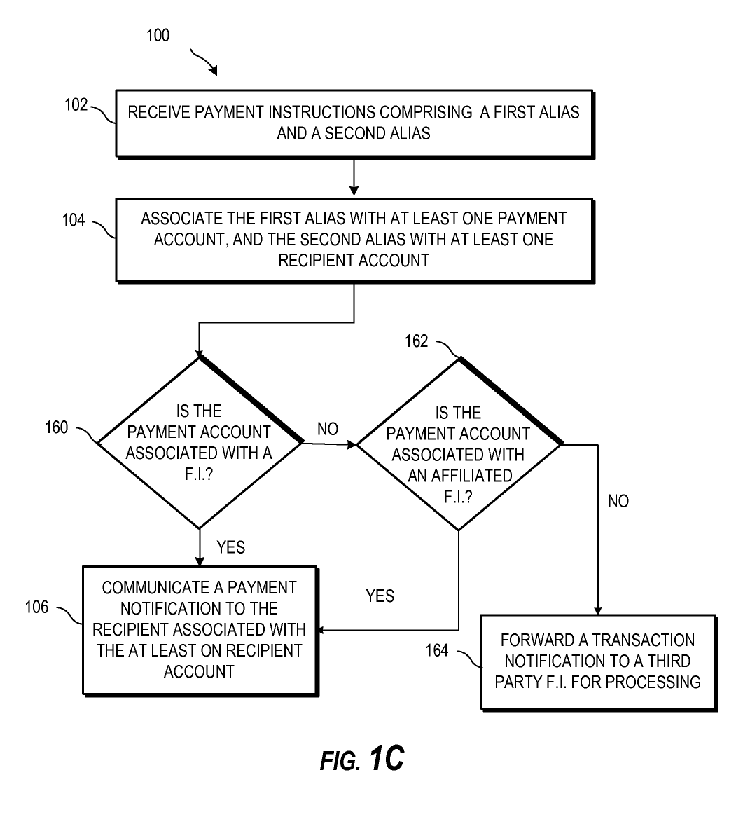

FIG. 1A is a flowchart providing an overview of a system and method 100 for making payments in accordance with one or more embodiments of the invention. It will be understood that one or more devices, such as one or more mobile device and/or one or more other computing devices and/or servers, can be configured to perform one or more steps of the method 100. In some embodiments, the one or more devices performing the steps are associated with a financial institution. In other embodiments, the one or more devices performing the steps are associated with a business, third party, and/or user. For example, in some embodiments, a “node” connects several networks or financial institutions such that money can be transferred from one customer of a financial institution to another customer of a different financial institution.

In block 102 of FIG. 1A, payment instructions comprising a first alias and a second alias are received. In some embodiments, the first alias is associated with a user. For example, the first alias may be generated by the user to send a payment without disclosing a payment account. Instead of using a credit card number, for example, a user may input an alias to make in-store or on online purchases. In other embodiments, the second alias is associated with a recipient. The second alias, for example, may include a POS device identifier and a payment amount associated with that POS device, or a mobile phone number. The alias may be any unique identifier other than the user's financial institution account number. Typically, the alias is an identifier that friends, family, and/or other members of the public uniquely associate with the user or any entity transferring or receiving a payment. For example, the alias may be a mobile telephone number, an email address, a social networking ID, a name, an address, a URL (uniform resource locator) address, a logo, a brand, a picture, graphical art, a trade name, a trade mark, a device, a loyalty card number, a merchant identifier, and/or any other textual, graphical, or visual indicator. The embodiments of the invention described herein in the other figures generally permit the user to use either a mobile telephone number or an email address as the account alias, but it will be appreciated that, in view of this disclosure, other embodiments of the invention may allow use of other types of aliases.

In some embodiments, the alias includes a number associated with a device. The number associated with the device may be a static or randomly generated number. The number associated with the device, in some embodiments, includes a random number. For example, in some embodiments, the random number is generated by an application that is synchronized or otherwise linked with a mobile device (e.g., the mobile device 400). The user may select the device, such as the type of smart phone, tablet, or other Wi-Fi enabled device, via a client application maintained on the user's device and synchronize the device with a financial institution's mobile application. In this way, the device itself appears to be the alias. The random number may be generated by a sequencing algorithm associated with a web-based mobile application maintained by a financial institution. In one particular example, the number associated with the device is communicable only between the client application on the device and the mobile web-based application maintained by a financial institution and cannot be used by any other entity. In other embodiments, the number associated with the device comprises a personal identification number (PIN). In some embodiments, the PIN comprises a random number for use in a specific transaction. For example, the user may input the PIN into a POS device instead of an account number when making a purchase.

The number associated with the device may include information associated with an account, a bank identification number (BIN), and a random number. For example, a digit or set of digits may be strategically placed at various points in the random number to indicate a particular account or financial institution. For instance, a ten digit number beginning with one specific digit and ending with another specific digit may indicate that the payment is associated with a particular bank and a particular payment account.

In block 103, the first alias and/or second alias is stored in a storage device. In some embodiments, the first alias and/or second alias is stored in alias data repository (e.g. the alias data repository 800). For example, a nickname, phone number, loyalty card number, or email address associated with one or more accounts may be stored the alias data repository for further use. In some embodiments, the first alias and/or second alias is removed from the storage device after a payment transaction associated with the first and/or second alias has been processed. For example, an application maintained by a financial institution may generate a random number in response to a payment request to provide an alias for a payment account. Once the random number is matched with the payment account and the payment transaction processed, the random may no longer be needed.

In block 104, the first alias is associated with at least one payment account, and the second alias is associated with at least one recipient account. In some embodiments, the at least one payment account and/or the at least one recipient account is associated with one or more financial institutions. For example, one payment account may be associated with a host financial institution, a second payment account may be associated with an affiliated financial institution, and a third payment account may be associated with a third party financial institution.

In one exemplary embodiment, the first alias is associated with a first and second account such that a portion of the payment amount is transferred from the first account and a portion of the payment amount is transferred from the second account. Similarly, the second alias may be associated with any number of recipient accounts such that portions of the payment amount may be transferred to multiple recipient accounts. For example, if a recipient wanted to set up a savings plan, half of a P2P payment could be transferred to a savings account, and the rest of the payment divided between two other accounts. In other embodiments, the entire payment amount is transferred from the at least one payment account. In still other embodiments, the entire payment is transferred to the at least one recipient account. In another embodiment, an account may be automatically selected based on a payment amount threshold. For example, if the payment amount is above $1000.00, then the payment may be transferred to a savings account, and if the payment amount is below $1000.00 the payment may be transferred to a checking account.

In some embodiments, the first alias includes a plurality of aliases. In other embodiments, the second alias includes a plurality of aliases. For example, the first and second aliases may include multiple aliases associated with a single account or plurality of accounts. A single checking account, for example, may be associated with an email address, a PIN, and a mobile phone number. In this way, the payment instructions may include any number of aliases associated with any number of accounts. In other embodiments, the first alias and/or second alias is associated with an additional alias. For example, an alias associated with a first user and a first account may be matched with another alias associated with the first user and a second account. In this way, additional aliases may be linked to additional accounts and the user or recipient is provided with a broader range of options for sending or receiving payments.

In block 106, a payment notification is communicated to a recipient, wherein the recipient is associated with the at least one recipient account. The recipient may be a person, a merchant, a POS device associated with a business, or any other entity capable of receiving payments. The recipient account may include checking accounts, savings accounts, businesses accounts, and any other account for receiving payments. In some embodiments, the payment notification includes a payment amount. The payment notification may further include the date and time of the notification, an alias associated with the sender, the sender's name, an account number, and the like.

Referring now to FIG. 1B, embodiments of the method 100 are further illustrated. In block 108, a payment amount is received from a recipient and/or user. For example, in some embodiments, the payment instructions include a payment amount. In block 110, the payment is transferred to the at least one recipient account.

In block 112, payment transactions associated with a user and/or recipient are monitored. For example, any purchases made using a P2P mobile client application on a mobile device may be tracked. In some embodiments, information associated with the payment transactions is determined. The information may include the time and date of a payment, the identity of the purchased products or services, the identity of the merchant, the purchase amount, and the like. In other embodiments, the transactions are grouped into categories. For example, online purchases; purchases associated with a particular merchant, product, service, or time period; or money transfers to a particular merchant or person may be grouped into separate categories. In block 114, a transaction history is presented to the user/and or recipient. The user, for example, may edit the transaction history. The user may choose to delete, save, or organize one or more transactions in the transaction history.

In block 116, a loyalty card associated with a user is identified. In some embodiments, the user is associated with the at least one payment account. In other embodiments, a P2P payment transaction is associated with a loyalty card. For example, the payment instructions or the first or second aliases may include a loyalty card number or an image of a loyalty card bar code. The user may also input a loyalty card number at a POS device. In block 118, rewards associated with the loyalty card are determined. For example, transactions associated with a loyalty card may be tracked to determine the total number of reward points available to the user. And in block 120, the rewards are presented to the user. The user may, for example, select a reward coupon using a display on a mobile phone to use the coupon when making a purchase.

Referring now to FIG. 1 C, embodiments of the method 100 are further illustrated. In block 102, payment instructions comprising a first alias and a second alias are received, and in block 104, the first alias is associated with at least one payment account, and the second alias is associated with at least one recipient account, as described above with regard to FIG. 1A.

In block 160, a decision is made as to whether the at least one payment account is associated with a financial institution. The financial institution includes the host financial institution or bank associated with the P2P payment. If the at least one payment account is associated with the financial institution, then a payment notification is communicated to the recipient associated with the at least one recipient account as shown in block 106.

If the at least one payment account is not associated with the financial institution, a decision is made as to whether the at least one payment account is associated with an affiliated financial institution as shown in block 162. The affiliated financial institution may include financial institutions that have agreed to participate in P2P payments, or financial institutions that are part of a network associated with P2P payments. If the at least one payment account is associated with an affiliated financial institution, then a payment notification is communicated to the recipient associated with the at least one recipient account as indicated in block 106.

If the at least one payment account is not associated with an affiliated financial institution, then a transaction notification is forwarded to a third party financial institution for processing as shown in block 164. The transaction notification may include a payment amount due, the first and second aliases, the at least one payment account, and/or the at least one recipient account. In some embodiments, the at least one payment account comprises a plurality of payment accounts associated with a plurality of financial institutions. In some cases, only the portion of the payment amount associated with the payment account of the third party financial institution is forwarded to the third party financial institution. For example, if half of the payment is to be transferred from a payment account associated with an affiliated financial institution and the other half is to be transferred from a payment account associated with the third party financial institution, then only the half of the payment is forwarded to the third party financial institution for processing.

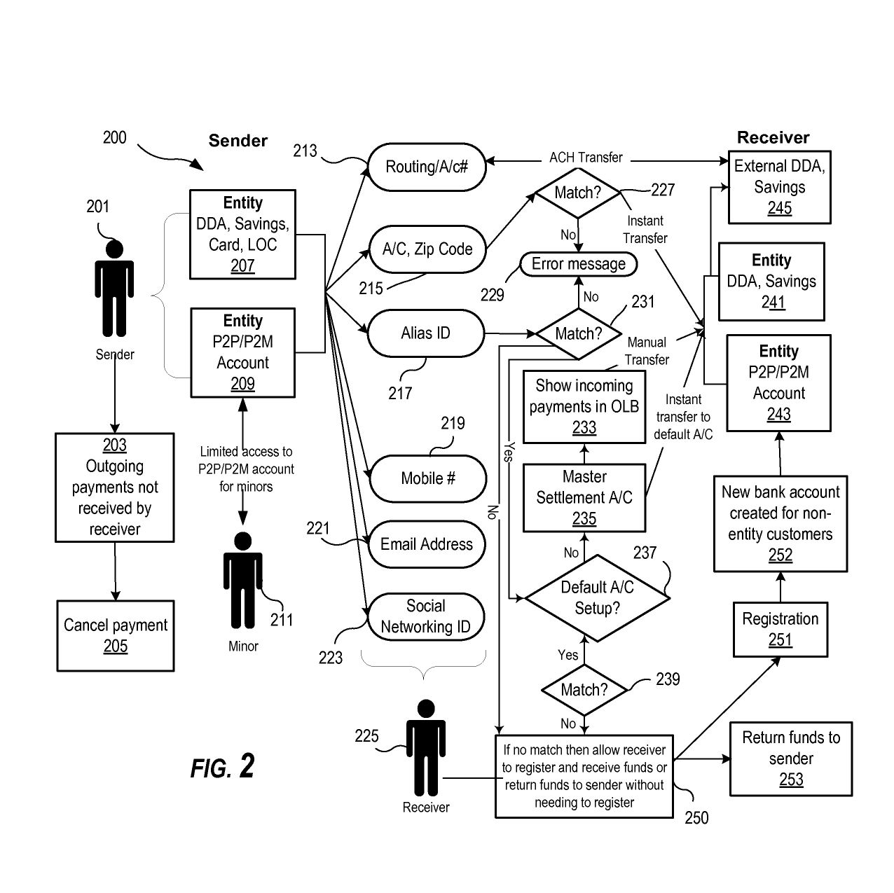

FIG. 2 is a combination block diagram and flowchart providing an overview of a system and method 200 for making P2P or online payments, in accordance with one or more embodiments of the invention. A sender 201 with an eligible account 207, e.g., checking (demand deposit account or “DDA”), savings, money market, line of credit, credit card, and the like, of a financial entity registers and makes use of this service. The sender includes a user, a merchant, customers of financial institution, non-customers of a financial institution, or any other individual or entity associated with an eligible account. During the registration process, the sender 201 is able to set up an alias identifier (ID) 217 (or simply an “alias”) that maps back to the customer's account.

The information provided by the sender 201 during registration of an alias may be verified to confirm that the sender 201 does have access to a mobile number 219, email address 221, social networking ID 223, a random number, or other alias 217 provided. For example, as described in greater detail below, the financial institution (or other entity that maintains a database of aliases and associates them with financial institution accounts) may send a communication to the sender 201 using the alias and require the sender 201 confirm access to the alias by responding to the notice in some way. For example, if the alias registered by the sender 201 is the mobile telephone number 219, the financial institution may send a text message to the mobile telephone number 219 with a code and then require that the sender 201 enter the code into a mobile banking or online banking application to confirm that the mobile telephone number is associated with the sender 201. Once the alias information is verified, the alias is linked to one or more of the sender's financial institution accounts in a data repository maintained by the financial institution or some other entity that provides an alias registry service to the financial institution.

The sender 201 can also use embodiments of the invention to make payments to other entity's, such as receiver 225, using an alias of the receiver 225. In some embodiments of the invention, the sender 201 is able to set preferences for accounts to be used for outgoing payments, and default account(s) for incoming payments. In some embodiments of the invention, the financial institution places maximums on how much money can be sent or received over a specified period of time using P2P payment aliases, and such limits may be based on the sender, the receiver, whether the receiver is a sender of the financial institution or a partner financial institution, account history, credit ratings, sender status, whether the sender has registered the alias, and/or any other relevant information. In some embodiments, the sender 201 can also establish limits on P2P payments. For example, a sender 201 may want to set a maximum of $1000 for P2P payments where an alias is used for the recipient as opposed to an account number.

In some embodiments of the invention, the sender 201 may also have an option of opening a new P2P account 209 with the financial institution that the sender may use exclusively for making and/or receiving P2P payments. This financial entity P2P account 209 may be like any other account hosted at the financial entity and so money may be moved instantly into this account 209 through the regular online banking transfer process for moving money between a sender's accounts. This account 209 may be a type of checking account except that it may come with certain limitations, e.g., no checks, maximum balance limits, number of daily transactions or the like, and may be opened by senders by providing much less information as compared to a regular checking account. The financial entity may, at a minimum, require senders to provide certain information, such as name, address, date of birth, and social security number, in order to comply with Anti-Money Laundering (AML) regulations. Senders 201 of the financial entity may also have an option to set up P2P accounts 209 (i.e., sub-accounts) for minors 211, other dependents, or related entities. Senders 201 are able to access these accounts just like any of their other accounts. In addition, senders 201 are able to set up an online banking access ID for the minor 211 that the minor 211 may use to sign into online banking but have access only to the specific minor P2P account 209 set up for them. These P2P-specific accounts and sub-accounts are described in more detail in U.S. patent application Ser. No. 12/038,177 filed on Feb. 27, 2008 and entitled “Sub-Account Mechanism,” which application was assigned to, or subject to an obligation to assign to, the same assignee of the present application at the time of filing of the present application and at the time of conception of the inventions described herein.

Referring again to FIG. 2, senders 201 of the financial entity are able to make payments to other people through any of a number of different methods. Payments may be made by a routing number/account number 213. Payments may be transferred directly to an external DDA or saving account 245. Payments may also be made by providing an account number and an additional identifier, such as a zip code 215. If there is a match 227 to an existing financial entity account, then the funds are transferred instantly to that account. Else, an error message 229 may be generated.

In accordance with embodiments of the invention, payments may be made by providing an alias 217. In general, as described in greater detail below, the sender 201 initiates a P2P payment using an alias by communicating an alias 217 and an associated payment amount to the financial institution. The financial institution then accesses an alias database, or other type of data repository, to determine if the entered alias 217 has been registered by the alias holder and is, thereby, associated with a particular financial institution account. If the alias 217 does have a match 231 to another sender in or financial institution account of another sender, then the payment may be initiated to that person, as described in greater detail below. If there is no match, then either the error message 229 is generated or, if possible, the alias 217 may be used to contact the intended recipient and allow this person to register the alias 217 and thereby associate the alias with a financial institution account. At any time, if outgoing payments or payment notifications are not received by a receiver (as represented by block 203), the payment may be canceled (as represented by block 205).

In some embodiments of the invention, an alias 217 may be associated with multiple financial institution accounts of the alias holder. In some such embodiments, the alias holder may be able to establish a default account when registering the alias 217 or afterwards. Consequently, if a receiver 225 does have a default account for incoming payments in 237, then the funds may be transferred instantly to that account(s). If the receiver 225 has not set up a default account in 237 but the receiver 225 does have multiple accounts associated with the alias 217, then the funds may be moved to a master settlement account 235 and the receiver 225 may see the payment as an incoming payment within online banking 233. The receiver 225 may then be able to use the online banking application to move the funds instantly to any of the receiver's others accounts. In other embodiments, however, each alias 217 is associated only with one financial institution account and, therefore, steps 237 and 235 are not needed and the payment is deposited directly into the one financial institution account associated with the alias 217.

As further illustrated in FIG. 2, the alias 217 may be a mobile telephone number 219 and, as such, payment may be made by the sender 201 providing a mobile phone number 219 (the mobile telephone number 219 being the mobile telephone number of the intended payment recipient 225) along with an associated payment amount. This operation may perform exactly as described above for the alias 217 if there is a match in 239 on the mobile number. If there is no match in 239, then a text message may be sent to the mobile number 219 provided (as represented by block 250). If the receiver 225 of the message is an existing financial institution customer (or, in some embodiments, if the receiver 225 is a customer of a partner financial institution), then that person may be allowed to sign into their online or mobile banking account, register the phone number as illustrated by block 251 (thereby associating the phone number with a financial institution account for P2P payment purposes), and then receive funds similar to the process described above for the alias 217. If the receiver 225 is not a financial entity customer with an account eligible for receiving funds, then the receiver 225 may be given the option to sign up (as represented by block 252) for a financial institution account 241 or 243 at the financial institution or return funds to the sender (as represented by block 253). In some embodiments, the funds in the accounts 241 and 243 are transferred to an external account 245.

As further illustrated in FIG. 2, the alias 217 may be the email address 221 and, as such, payment may be made by the sender 201 providing an email address 221 (the email address 221 being an email address of the intended payment recipient 225) along with an associated payment amount. This operation may perform exactly as described above for a mobile number 219 except that the notification message (with the registration or account opening option if appropriate) is sent to the email address 221 provided.

In some embodiments of the invention, payment may be made by providing a social networking ID 223, such as a unique ID associated with the receiver 225 on a particular social networking Internet site. In such a situation, the process operates in the same way as described above for mobile phone number 219 and email address 221 except the social networking platform may be used to notify the receiver based on the social networking ID 223 provided.

In all cases described above, if the receiver 225 is already a customer of the financial institution or a partner financial institution and has already registered the alias 217 provided by the sender 201, a text message, email, online banking notice, mobile banking notice, or other type of message may be sent to receiver 225 based on the alias 217 entered by the sender 201 or irrespective of information entered by sender if there is other contact information found in the receiver's profile, the notification notifying the receiver 225 of the payment. In some embodiments, the receiver 225 may be allowed to reject or re-route the payment. In some embodiments of the invention, the sender 201 is permitted to include a note to the recipient 225 along with the payment, such as a note explaining to the recipient what the purpose of payment.

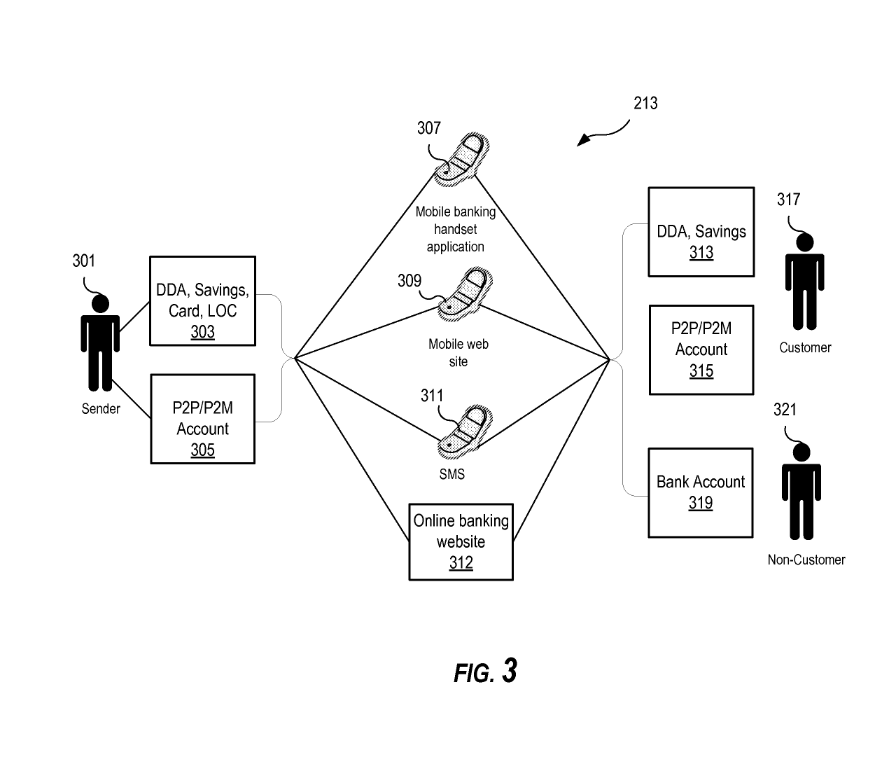

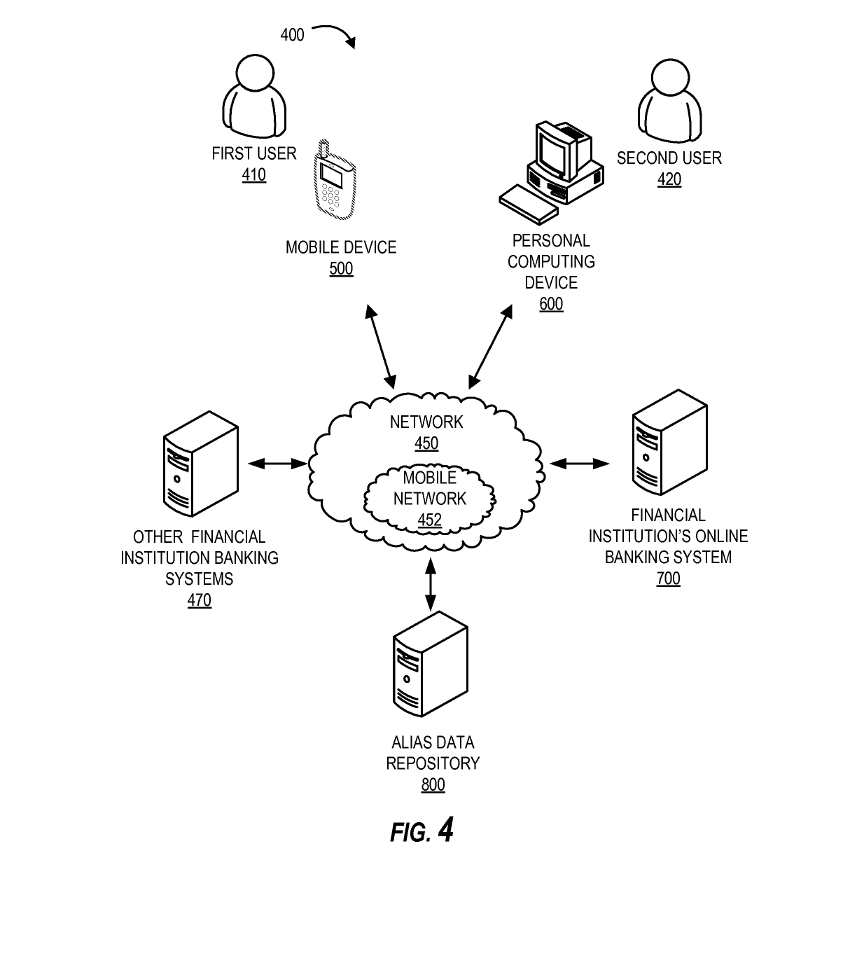

FIG. 3 is a block diagram illustrating the various ways through which a sender may make P2P payments in accordance with various embodiments of the invention. As illustrated, in some embodiments of the invention, a sender 301 who is signed up for the P2P payment service has the option to initiate P2P payments from a DDA, savings, line of credit, and/or credit card account 303 of the financial entity (and/or from a P2P-specific account 305 with the financial entity) through the financial entity's mobile banking website 309 or a mobile banking handset application 307 by providing any of the above-described alias information, e.g., phone number, email address, social networking ID, and/or other alias, along with a payment amount. In some embodiments of the invention, senders can alternatively or additionally initiate payments by sending a text message 311 to the financial entity, the text message including the receiver's phone number, email address, social networking ID, nickname, or other alias. In some embodiments, senders can alternatively or additionally use the financial institution's online banking website 312 to initiate a payment using an alias, as described in greater detail below with respect to FIGS. 4-11C. Whether via a mobile banking handset application 307, mobile website 309, short message service 311, or online banking website 312, a receiver 317 associated with the financial entity may receive funds at the receiver's financial institution account (e.g., DDA, savings, or credit account 313 or P2P-specific account 315). A receiver 321 not associated with the financial entity may receive funds at the receiver's financial institution account 319 at another partner financial institution if the account is registered and associated with the alias and/or the receiver 321 may be prompted to register for the service and/or open an account with the financial institution in order to receive the payment from the sender 301.

It should be appreciated that embodiments of the invention described above permit an entity to send money to another entity even if the sending entity does not know any account information for the recipient entity and only knows a mobile telephone number or email address of the recipient entity. This can also result in better protection of personal account information. It should also be appreciated that some embodiments of the invention create a viral registration and/or account opening system that allows for customers of a financial institution to send payments to anyone outside the financial entity using an alias. In such embodiments, the non-customers are contacted using the alias and they are allowed to quickly open and/or register an account with the financial institution in order to receive the funds from the sender.

As described above, FIG. 1 provides an overview of a P2P payment system, and FIGS. 2 and 3 provide an overview of the alias-type P2P payment system and process of embodiments of the invention. FIGS. 4-11C, described below, provide a more detailed description of some systems and methods of implementing embodiments the invention in an online banking environment.

### Online Banking P2P Payment System and Environment

FIG. 4 provides a block diagram illustrating an online banking P2P payment system and environment 400, in accordance with an embodiment of the invention. As illustrated in FIG. 4, the P2P payment environment 400 includes a first user 410 and a second user 420 where the first user wants to send funds to a second user. A user of the system may be a person, but may also be a business (e.g., a merchant), customer or a merchant, or any other entity capable of sending or receiving money.

The environment 400 also includes a mobile device 500 and a personal computing device 600 for the first user 410 and the second user 420, respectively. The personal computing device may be any device that employs a processor and memory and can perform computing functions, such as a personal computer or a mobile device. As used herein, a “mobile device” is any mobile communication device, such as a cellular telecommunications device (i.e., a cell phone or mobile phone), personal digital assistant (PDA), a mobile Internet accessing device, or other mobile device. Although a mobile device is illustrated, it will be understood that any internet connected device may be used, including, for example, an ATM, a computer, and the like.

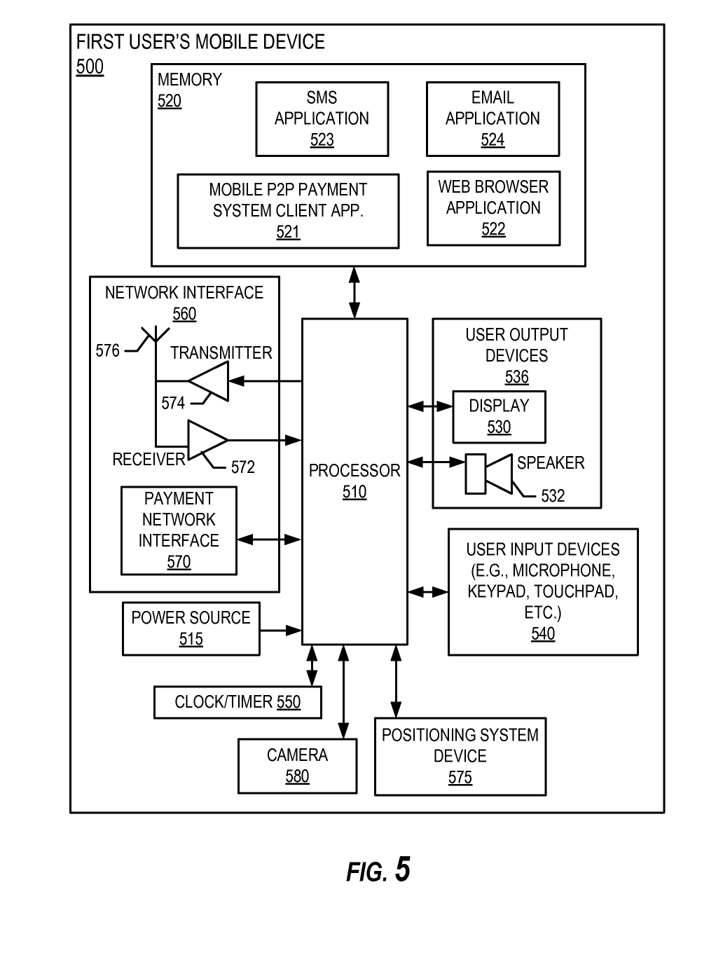

The mobile device 500 and personal computing device 600 are configured to communicate over a network 450 with a financial institution's online banking system 700 and, in some cases, one or more other financial institution banking systems 470. The first user's mobile device 500, the second user's personal computing device 600, the financial institution's online banking system 700, an alias data repository 800, and any other participating financial institution's banking systems 470 are each described in greater detail below with reference to FIGS. 5-8. The network 450 may include a local area network (LAN), a wide area network (WAN), and/or a global area network (GAN). The network 450 may provide for wireline, wireless, or a combination of wireline and wireless communication between devices in the network. In one embodiment, the network 450 includes the Internet. In one embodiment, the network 450 includes a wireless telephone mobile network 452.

In general, the mobile device 500 is configured to connect with the network 450 to log the first user 410 into an online banking system 700. The online banking system 700 involves authentication of a user in order to access the user's account on the online banking system 700. For example, the online banking system 700 is a system where the first user 410 logs into his/her account such that the first user 410 or other entity can access data that is associated with the first user 410. For example, in one embodiment of the invention, the online system 700 is an online banking system maintained by a financial institution. In such an embodiment, the first user 410 can use the mobile device 500 to log into the online banking system to access the merchant online banking account. Logging into the online banking system 700 generally requires that the first user 410 authenticate his/her identity using a user name, a passcode, a cookie, a biometric identifier, a private key, a token, and/or another authentication mechanism that is provided by the first user 410 to the online banking system 700 via the mobile device 500.

The financial institution's banking system 700 is in network communication with other devices, such as third party's financial institution banking systems 470, an alias data repository 800, and a personal computing device 600 that is configured to communicate with the network 450 to log the second user 420 into the banking system 700.

In some embodiments of the invention, the alias data repository 800 is configured to be controlled and managed by one or more third-party data providers (not shown in FIG. 4) over the network 450. In other embodiments, the alias data repository 800 is configured to be controlled and managed over the network 450 by the same entity that maintains the financial institution's online banking system 700. In other embodiments, the alias data repository 800 is configured to be controlled and managed over the network 450 by the financial institution implementing the online payment system of the present invention. In still other embodiments, the alias data repository 800 is a part of the online banking system 700.

FIG. 5 provides a block diagram illustrating the consumer mobile device 500 of FIG. 4 in more detail, in accordance with some embodiments. In one embodiment of the invention, the mobile device 500 is a mobile telephone. However, it should be understood, however, that a mobile telephone is merely illustrative of one type of mobile device 500 that may benefit from, employ, or otherwise be involved with embodiments of the present invention and, therefore, should not be taken to limit the scope of embodiments of the present invention. Other types of mobile devices 500 may include portable digital assistants (PDAs), pagers, mobile televisions, gaming devices, laptop computers, cameras, video recorders, audio/video player, radio, GPS devices, tablets, Wi-Fi enabled devices, or any combination of the aforementioned.

The mobile device 500 generally includes a processor 510 communicably coupled to such devices as a memory 520, user output devices 536, user input devices 540, a network interface 560, a power source 515, a clock or other timer 550, a camera 580, and a positioning system device 575. The processor 510, and other processors described herein, generally include circuitry for implementing communication and/or logic functions of the mobile device 500. For example, the processor 510 may include a digital signal processor device, a microprocessor device, and various analog to digital converters, digital to analog converters, and/or other support circuits. Control and signal processing functions of the mobile device 500 are allocated between these devices according to their respective capabilities. The processor 510 thus may also include the functionality to encode and interleave messages and data prior to modulation and transmission. The processor 510 can additionally include an internal data modem. Further, the processor 510 may include functionality to operate one or more software programs, which may be stored in the memory 520. For example, the processor 510 may be capable of operating a connectivity program, such as a web browser application 522. The web browser application 522 may then allow the mobile device 500 to transmit and receive web content, such as, for example, location-based content and/or other web page content, according to a Wireless Application Protocol (WAP), Hypertext Transfer Protocol (HTTP), and/or the like.

The processor 510 is configured to use the network interface 560 to communicate with one or more other devices on the network 450. In this regard, the network interface 560 includes an antenna 576 operatively coupled to a transmitter 574 and a receiver 572 (together a “transceiver”). The processor 510 is configured to provide signals to and receive signals from the transmitter 574 and receiver 572, respectively. The signals may include signaling information in accordance with the air interface standard of the applicable cellular system of the wireless telephone network 452. In this regard, the mobile device 500 may be configured to operate with one or more air interface standards, communication protocols, modulation types, and access types. By way of illustration, the mobile device 500 may be configured to operate in accordance with any of a number of first, second, third, and/or fourth-generation communication protocols and/or the like. For example, the mobile device 500 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 500 may also be configured to operate in accordance with non-cellular communication mechanisms, such as via a wireless local area network (WLAN) or other communication/data networks.

The network interface 560 may also include a payment network interface 570. The payment network interface 570 may include software, such as encryption software, and hardware, such as a modem, for communicating information to and/or from one or more devices on a network 450. For example, the mobile device 500 may be configured so that it can be used as a credit or debit card by, for example, wirelessly communicating account numbers or other authentication information to a terminal of the network 450.

As described above, the mobile device 500 has a user interface that is, like other user interfaces described herein, made up of user output devices 536 and/or user input devices 540. The user output devices 536 include a display 530 (e.g., a liquid crystal display or the like) and a speaker 532 or other audio device, which are operatively coupled to the processor 510. The user input devices 540, which allow the mobile device 500 to receive data from a user such as the first user 410, may include any of a number of devices allowing the mobile device 500 to receive data from a user, such as a keypad, keyboard, touch-screen, touchpad, microphone, mouse, joystick, other pointer device, button, soft key, and/or other input device(s). The user interface may also include a camera 580, such as a digital camera.

The mobile device 500 may also include a positioning system device 575 that is configured to be used by a positioning system to determine a location of the mobile device 500. For example, the positioning system device 575 may include a GPS transceiver. In some embodiments, the positioning system device 575 is at least partially made up of the antenna 576, transmitter 574, and receiver 572 described above. For example, in one embodiment, triangulation of cellular signals may be used to identify the approximate location of the mobile device 500. In other embodiments, the positioning system device 575 includes a proximity sensor or transmitter, such as an RFID tag, that can sense or be sensed by devices known to be located proximate a merchant or other location to determine that the consumer mobile device 500 is located proximate these known devices.

The mobile device 500 further includes a power source 515, such as a battery, for powering various circuits and other devices that are used to operate the mobile device 500. Embodiments of the mobile device 500 may also include a clock or other timer 550 configured to determine and, in some cases, communicate actual or relative time to the processor 510 or one or more other devices.

The mobile device 500 also includes a memory 520 operatively coupled to the processor 510. As used herein, memory includes any computer readable medium (as defined herein below) configured to store data, code, or other information. The memory 520 may include volatile memory, such as volatile Random Access Memory (RAM) including a cache area for the temporary storage of data. The memory 520 may also include non-volatile memory, which can be embedded and/or may be removable. The non-volatile memory can additionally or alternatively include an electrically erasable programmable read-only memory (EEPROM), flash memory or the like.

The memory 520 can store any of a number of applications which comprise computer-executable instructions/code executed by the processor 510 to implement the functions of the mobile device 500 described herein. For example, the memory 520 may include such applications as a conventional web browser application 522, an email application 524, a short message service (SMS) application 523, and/or a mobile P2P payment system client application 521. These applications also typically provide a graphical user interface (GUI) on the display 530 that allows the first user 410 to communicate with the consumer mobile device 500, the mobile banking system 700, and/or other devices or systems. In one embodiment of the invention, when the first user 410 decides to enroll in the mobile banking program, the first user 410 downloads or otherwise obtains the mobile banking system client application from the mobile banking system 700 or from a distinct application server. In other embodiments of the invention, the first user 510 interacts with the mobile banking system 700 via the web browser application 522 in addition to, or instead of, the mobile P2P payment system client application 521.

The memory 520 can also store any of a number of pieces of information, and data, used by the mobile device 500 and the applications and devices that make up the mobile device 500 or are in communication with the mobile device 500 to implement the functions of the mobile device 500 and/or the other systems described herein. For example, the memory 520 may include such data as user authentication information, and the like.

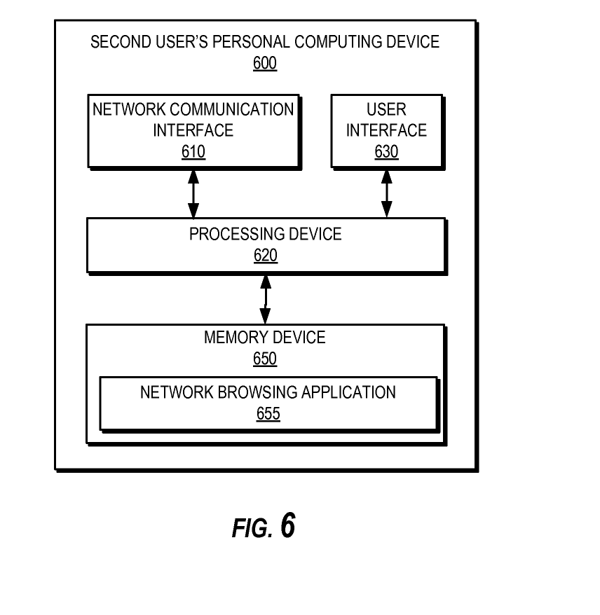

Referring now to FIG. 6, the personal computing device 600 associated with the user 420 also includes various features, such as a network communication interface 610, a processing device 620, a user interface 630, and a memory device 650. The network communication interface 610 includes a device that allows the personal computing device 600 to communicate over the network 450 (shown in FIG. 4). In addition, a network browsing application 655 is stored in the memory device 650. The network browsing application 655 provides for the user to establish network communication for the purpose of registering and account and/or alias with the online payment system and/or receiving online payment, in accordance with embodiments of the present invention.

As used herein, a “processing device,” such as the processing device 520 or the processing device 620, generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 620 may further include functionality to operate one or more software programs based on computer-executable program code thereof, which may be stored in a memory. As the phrase is used herein, a processing device 620 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “user interface” 630 generally includes a plurality of interface devices that allow a customer to input commands and data to direct the processing device to execute instructions. As such, the user interface 630 employs certain input and output devices to input data received from the first user 410 or second user 420 or output data to the first user 410 or second user 420. These input and output devices may include a display, mouse, keyboard, button, touchpad, touch screen, microphone, speaker, LED, light, joystick, switch, buzzer, bell, and/or other customer input/output device for communicating with one or more customers.

As used herein, a “memory device” 650 generally refers to a device or combination of devices that store one or more forms of computer-readable media and/or computer-executable program code/instructions. Computer-readable media is defined in greater detail below. For example, in one embodiment, the memory device 650 includes any computer memory that provides an actual or virtual space to temporarily or permanently store data and/or commands provided to the processing device 620 when it carries out its functions described herein.

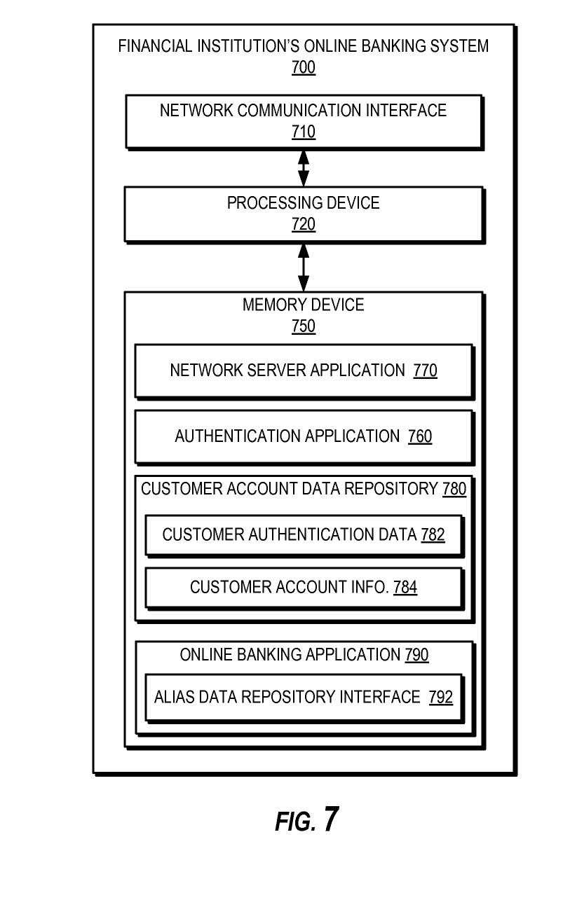

FIG. 7 provides a block diagram illustrating the online banking system 700 in greater detail, in accordance with embodiments of the invention. As illustrated in FIG. 7, in one embodiment of the invention, the online banking system 700 includes a processing device 720 operatively coupled to a network communication interface 710 and a memory device 750. In certain embodiments, the online banking system 700 is operated by a first entity, such as a financial institution, while in other embodiments, the online banking system 700 is operated by an entity other than a financial institution.

It should be understood that the memory device 750 may include one or more databases or other data structures/repositories. The memory device 750 also includes computer-executable program code that instructs the processing device 720 to operate the network communication interface 710 to perform certain communication functions of the online banking system 700 described herein. For example, in one embodiment of the online banking system 700, the memory device 750 includes, but is not limited to, a network server application 770, an authentication application 760, a customer account data repository 780, which includes customer authentication data 782 and customer account information 784, and an online banking application 790, which includes an alias data repository interface 792 and other computer-executable instructions or other data. The computer-executable program code of the network server application 770, the authentication application 760, or the online banking application 790 may instruct the processing device 720 to perform certain logic, data-processing, and data-storing functions of the online system 700 described herein, as well as communication functions of the online banking system 700.

In one embodiment, the customer account data repository 780 includes customer authentication data 782 and customer account information 784. The network server application 770, the authentication application 760, and the online banking application 790 are configured to implement customer account information 784, the customer authentication data 782, and the alias data repository interface 792 when authenticating the sender 201 to the online banking system 700. The customer account information 784, the customer authentication data 782, and the alias data repository interface 792 are discussed in more detail in a later section.

As used herein, a “communication interface” generally includes a modem, server, transceiver, and/or other device for communicating with other devices on a network, and/or a user interface for communicating with one or more customers. Referring again to FIG. 7, the network communication interface 710 is a communication interface having one or more communication devices configured to communicate with one or more other devices on the network 450, such as the mobile device 500 or personal computing device 600, the online banking system 700, the other financial institution banking systems 470, and the alias data repository 800. The processing device 720 is configured to use the network communication interface 710 to transmit and/or receive data and/or commands to and/or from the other devices connected to the network 450.

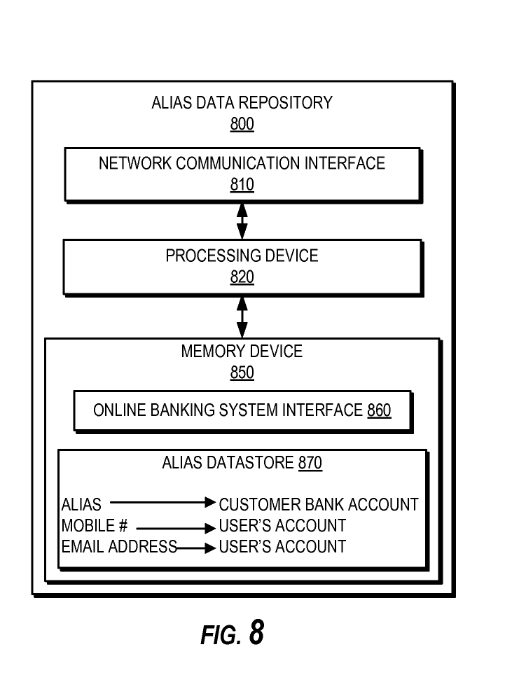

FIG. 8 provides a block diagram illustrating an alias data repository 800, in accordance with an embodiment of the invention. In one embodiment of the invention, the alias data repository 800 is operated by a second entity that is a different or separate entity from the first entity (e.g., the financial institution) that, in one embodiment of the invention, implements the online banking system 700. In one embodiment, the alias data repository 800 could be part of the online banking system 700. In another embodiment, the alias data repository 800 is a distinct entity from the online banking system 700. As illustrated in FIG. 8, the alias data repository 800 generally includes, but is not limited to, a network communication interface 810, a processing device 820, and a memory device 850. The processing device 820 is operatively coupled to the network communication interface 810 and the memory device 850. In one embodiment of the alias data repository 800, the memory device 850 stores, but is not limited to, an online banking system interface 860 and an alias data store 870. The alias data store 870 stores data including, but not limited to, an alias for the customer's financial institution account, mobile number or email address for the merchant's 410 account, and a mobile number and/or email address for the user's 420 account. In one embodiment of the invention, both the online banking system interface 860 and the alias data store 870 may associate with applications having computer-executable program code that instructs the processing device 820 to operate the network communication interface 810 to perform certain communication functions involving the alias data store 870 described herein. In one embodiment, the computer-executable program code of an application associated with the alias data store 870 may also instruct the processing device 820 to perform certain logic, data processing, and data storing functions of the application associated with the alias data store 870 described herein. An alias, as defined in this invention, is not limited to just a mobile device number or an email address.

The network communication interface 810 is a communication interface having one or more communication devices configured to communicate with one or more other devices on the network 450. The processing device 820 is configured to use the network communication interface 810 to receive information from and/or provide information and commands to a mobile device 500 or personal computing device 600, other financial institution banking systems 470, the alias data repository 800, the online banking system 700 and/or other devices via the network 450. In some embodiments, the processing device 820 also uses the network communication interface 810 to access other devices on the network 450, such as one or more web servers of one or more third-party data providers. In some embodiments, one or more of the devices described herein may be operated by a second entity so that the third-party controls the various functions involving the alias data repository 800. For example, in one embodiment of the invention, although the online system 700 is operated by a first entity (e.g., a financial institution), a second entity operates the alias data repository 800 that stores the alias details for the customer's financial institution accounts and other information about customers.

As described above, the processing device 820 is configured to use the network communication interface 810 to gather data from the various data sources. The processing device 820 stores the data that it receives in the memory device 850. In this regard, in one embodiment of the invention, the memory device 850 includes datastores that include, for example: (1) aliases for customer financial institution account numbers and routing information, (2) information about sending and receiving users' mobile device numbers, email addresses, or other contact information, which may have been received from the online banking system 700; (3) a list of customer IDs or authentication data received from the online banking system 700; and/or (4) customer credentials (e.g., a customer ID) received from the first user's mobile device 500 or received from the online system in response to the user accessing the online banking system 700.

In some embodiments, an application server is provided to support various supporting systems on the network 450, including the wireless telephone mobile network 352. The application server includes a network communication interface, a processing device, and a memory device. The network communication interface and the processing device are similar to the previously described network communication interface 710 processing device 720. For example, the processing device is operatively coupled to the network communication interface and the memory device. In one embodiment of the application server, the memory device includes a network browsing application having computer-executable program codes that instruct the processing device to operate the network communication interface to perform certain communication functions of the application download server described herein. In some embodiments, the application download server provides applications that are to be downloaded to a user's mobile device or personal computing device.

### Mobile Banking P2P Payment Send Process and Interface

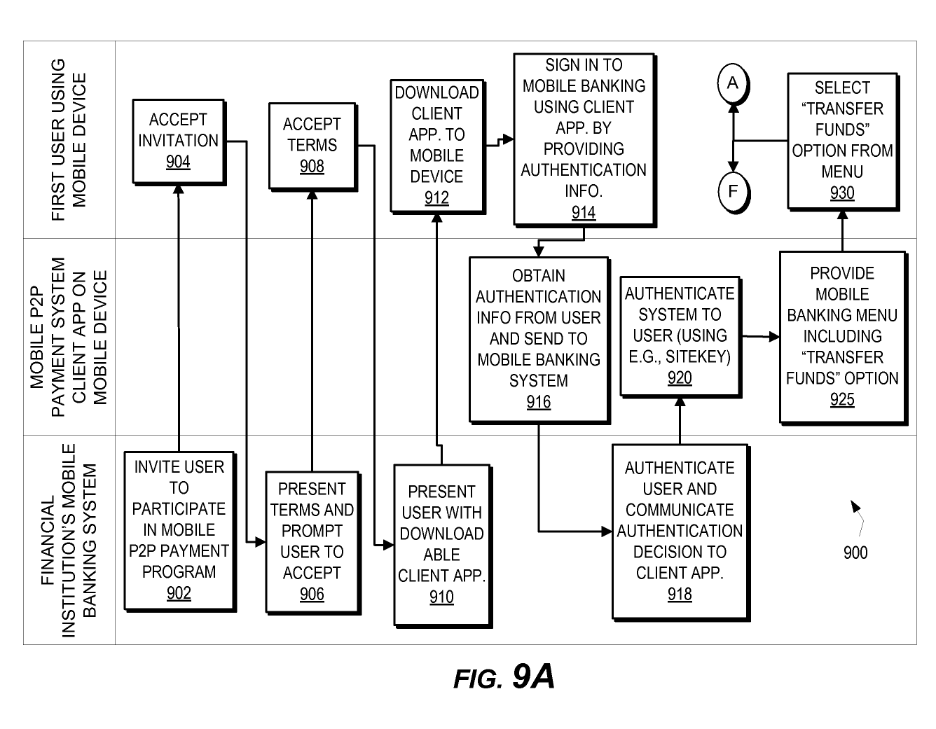

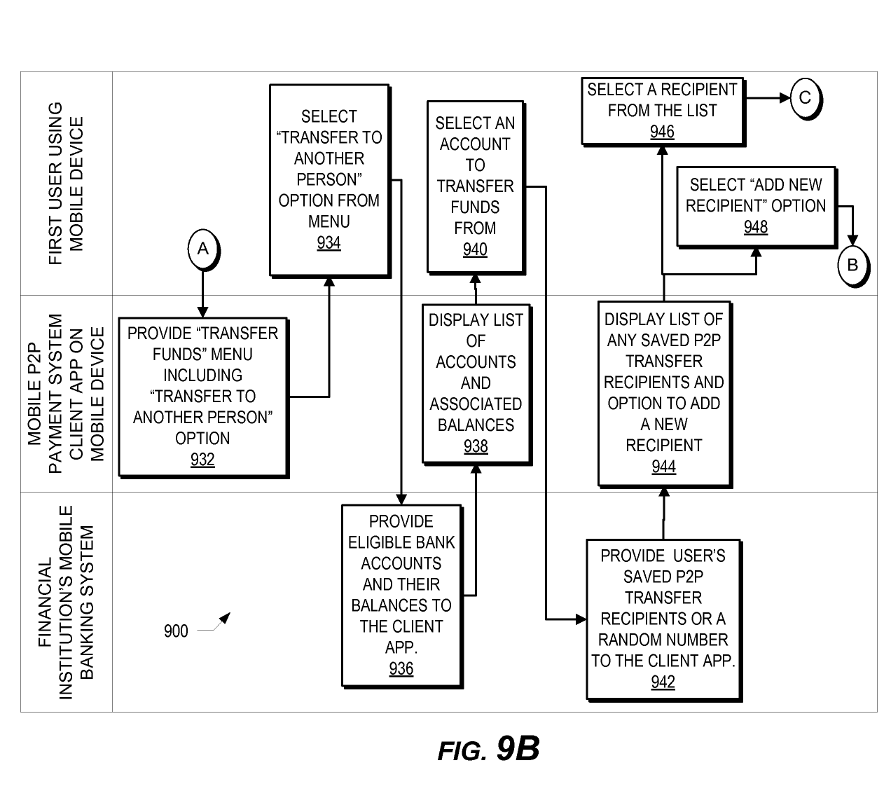

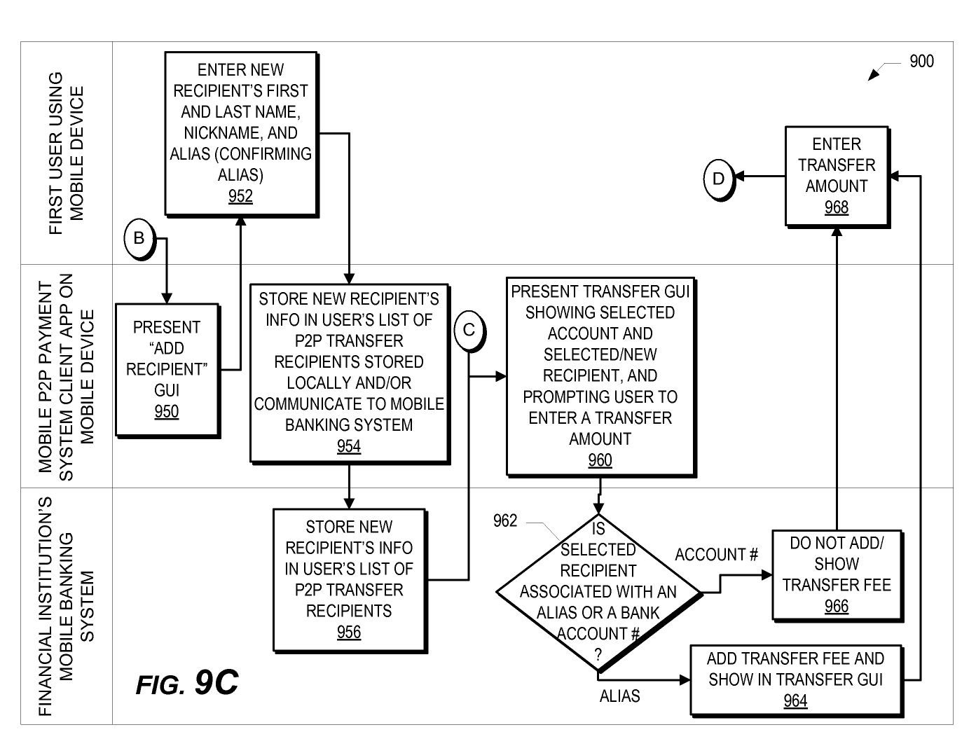

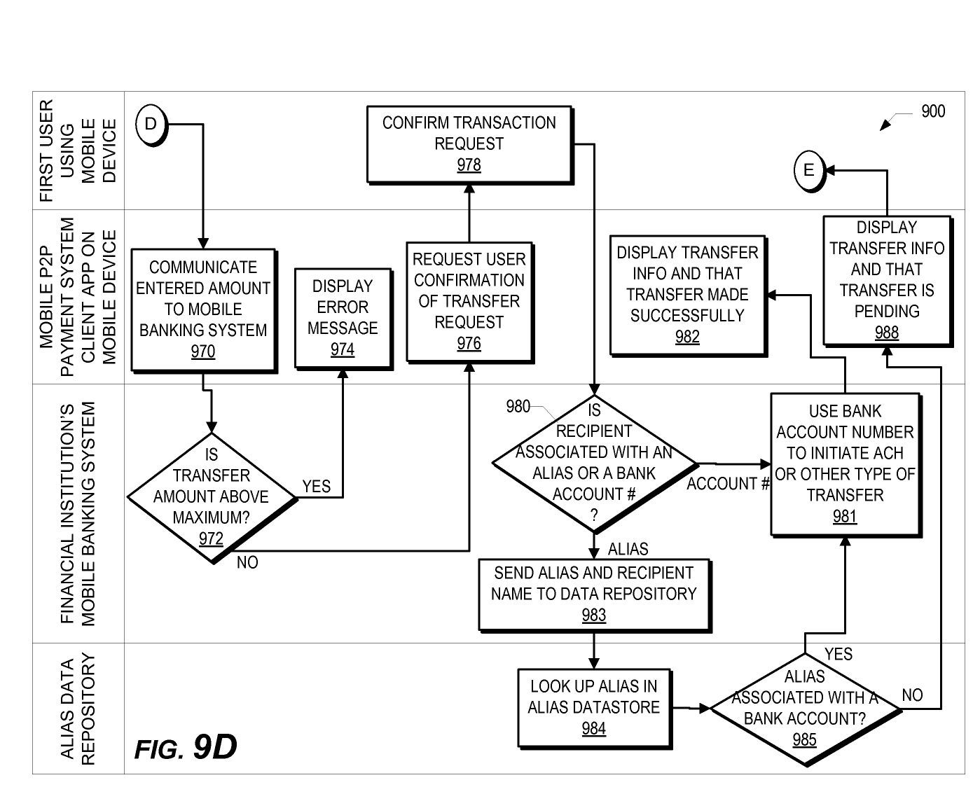

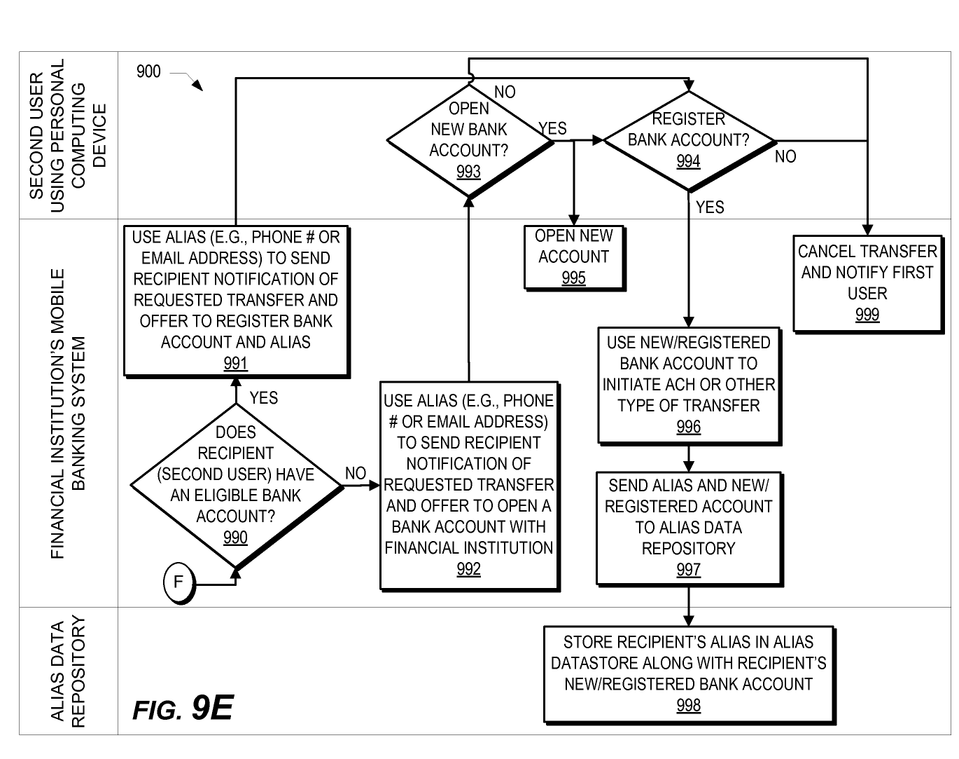

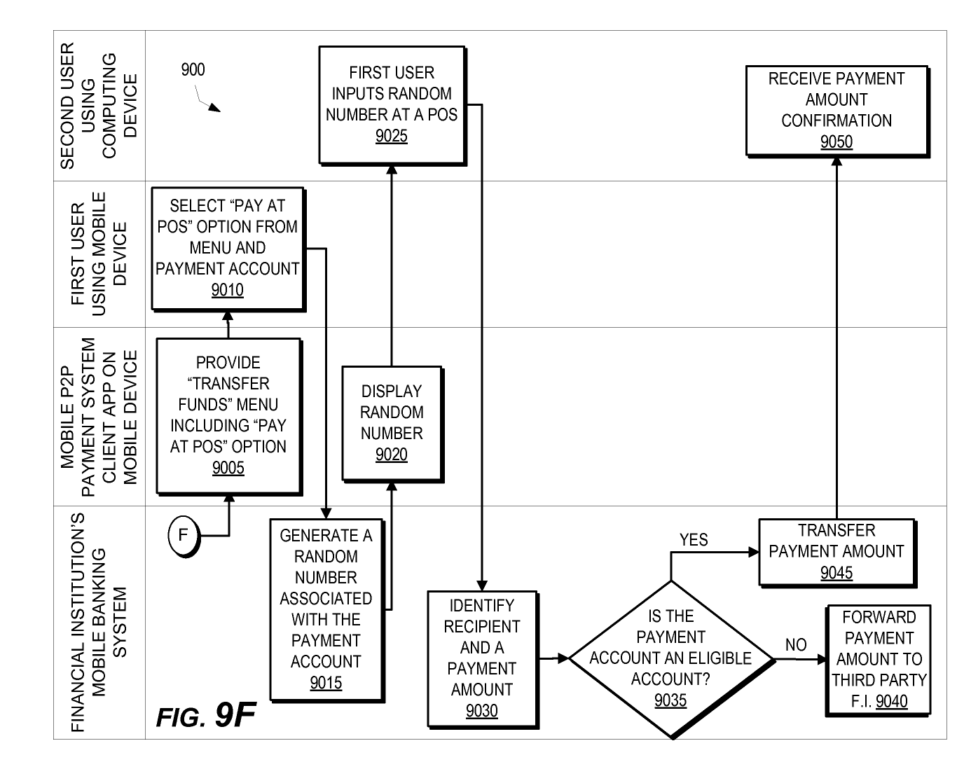

FIGS. 9A-9F provide flow charts illustrating a process 800 for sending P2P payments via alias using a mobile device, in accordance with an embodiment of the invention. FIGS. 9A-9F illustrate the flow chart in terms of “swim lanes” associated with entities which may perform the operations in each respective swim lane. The entities illustrated in the exemplary Figures are a financial institution's mobile banking system, a first user using a mobile device, an alias data repository, and a second user using a second personal computing device. However, it should be noted that other entities could also be involved and some embodiments of the invention may not be limited to the four entities illustrated in FIGS. 9A-9F. Additionally, it should be understood that, in other embodiments of the invention, the entities need not be required to perform the actions illustrated in each respective swim lane. For example, some of the process steps described herein may be performed by the first entity (or other entities) even though the element may be illustrated as in the swim lane of the second entity. Similarly, in some embodiments, some of the process steps may be performed by the second entity (or other entities) even though the element may be illustrated as in the swim lane of the first entity.

The process begins at block 902 of FIG. 9A where a financial institution's mobile banking system 700 invites a user to participate in a mobile P2P payment program. In one embodiment, the mobile banking system 700 only invites certain existing mobile banking users who fit certain criteria, including, but not limited to, pre-determined minimum account balance, number of years since the user first opened an account, and the like.

The process then moves to block 904 where the first user 410 using mobile computing device 400 accepts the invitation.

The process then moves to block 906 of FIG. 9A where the mobile banking system 700 presents to the first user the terms of the mobile P2P transfer feature that will govern the transfer of funds. In one embodiment, the first user can read the terms on the first user's mobile device 400, whereas in another embodiment, the first user can only read the terms on a personal computing device.

The process then moves to block 908 of FIG. 9A. The first user accepts the terms of the P2P service by activating an appropriate button on the mobile webpage.

The process then moves to block 910 of FIG. 9A where the mobile banking system 700 presents the first user with a downloadable client application.

The process then moves to block 912 of FIG. 9A where the first user 410 downloads the client application to the first user's mobile device 400.

The process then moves to block 914 of FIG. 9A where the first user 410 signs in to the mobile banking system 700 using the client application by providing appropriate authentication information.

The process then moves to block 916 of FIG. 9A where the mobile P2P payment system client application 794 on the mobile device 500 obtains authentication information from the first user and sends the authentication information to the mobile banking system 700.

The process them moves to block 918 of FIG. 9A where the mobile banking system 700 authenticates the first user 410 and communicates the authentication decision to the mobile P2P payment system client application 794.

The process then moves to block 920 of FIG. 9A where the mobile P2P payment system client application 794 authenticates the system to the first user 410. In one embodiment of the invention, the authentication is achieved using a web-based security system that provides mutual authentication between end-users and websites. In a challenge-response process of the security system, the first user has to identify himself or herself on a secure website by entering a username. Subsequently, the website authenticates itself to the first user by displaying an image and an accompanying phrase that the first user had previously configured. If the user recognizes this image and the accompanying phrase, the first user can authenticate himself or herself to the website by entering a password. Other embodiments of the invention may use other authentication systems.

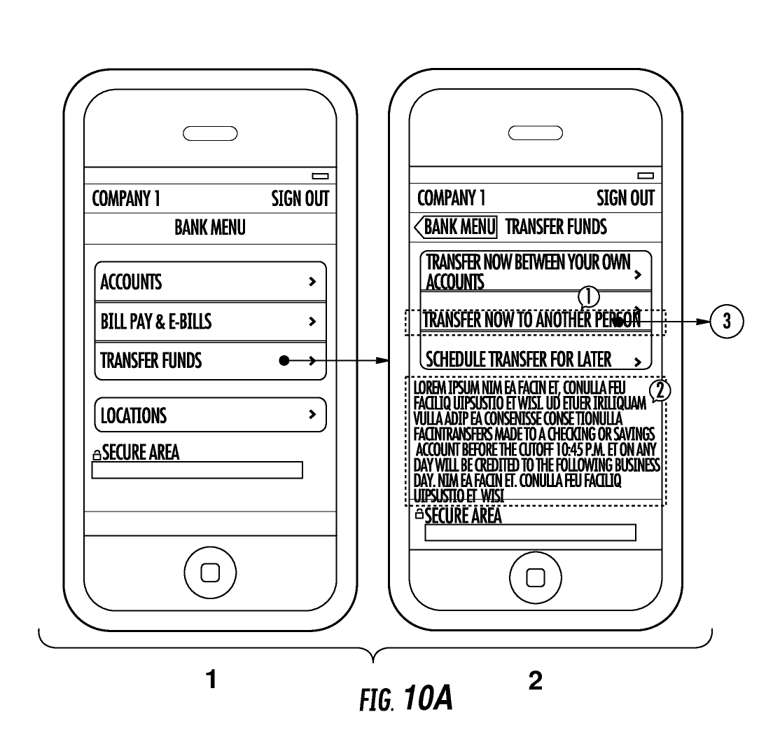

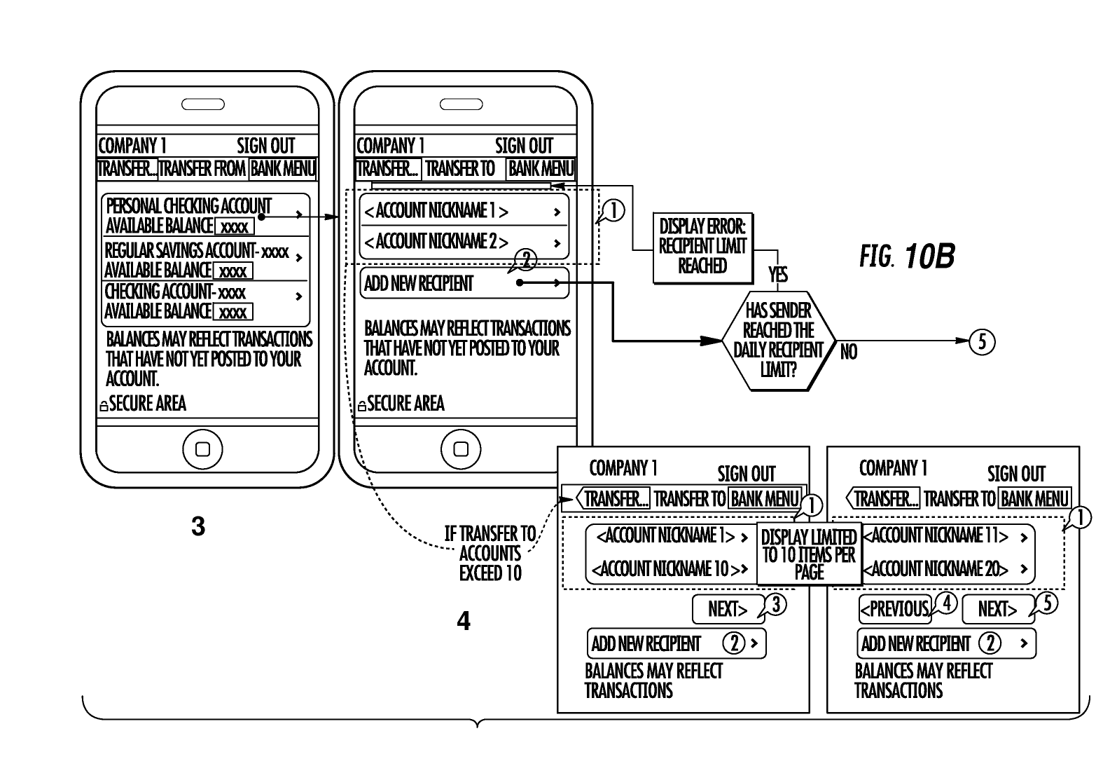

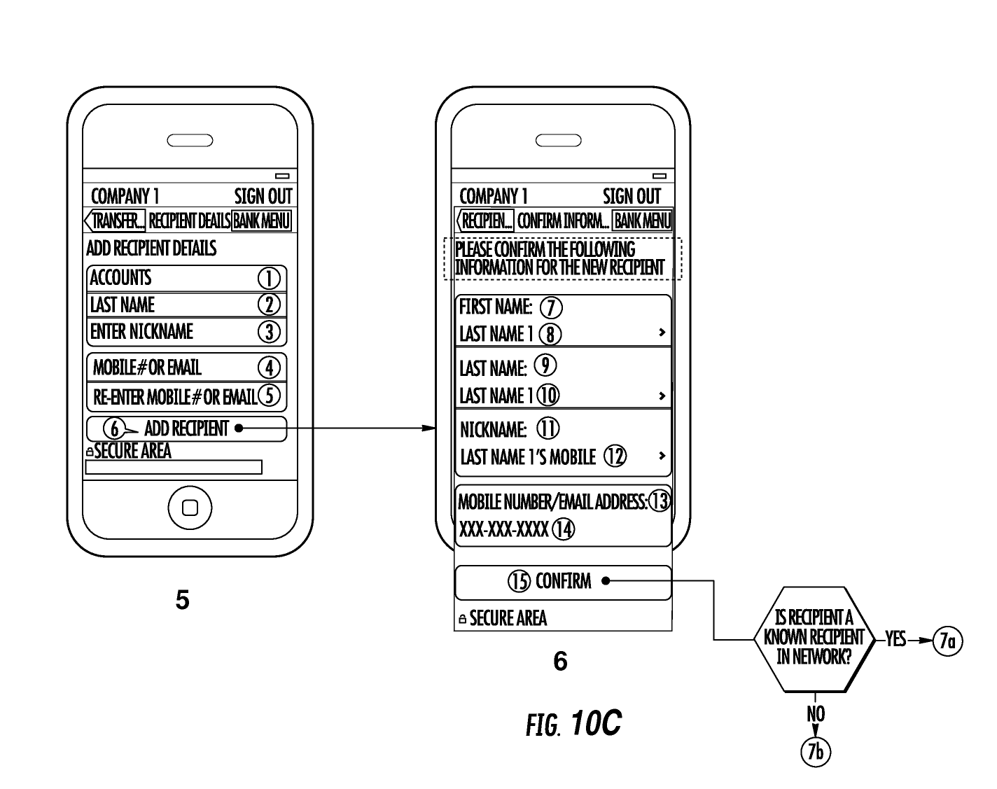

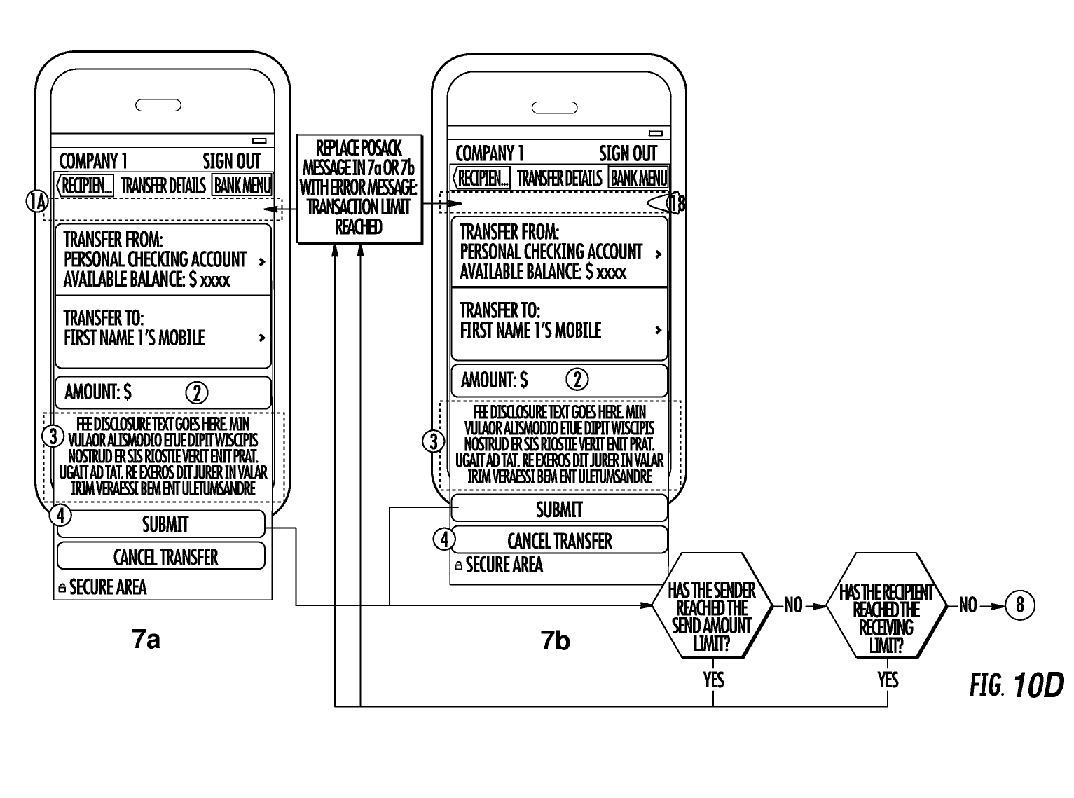

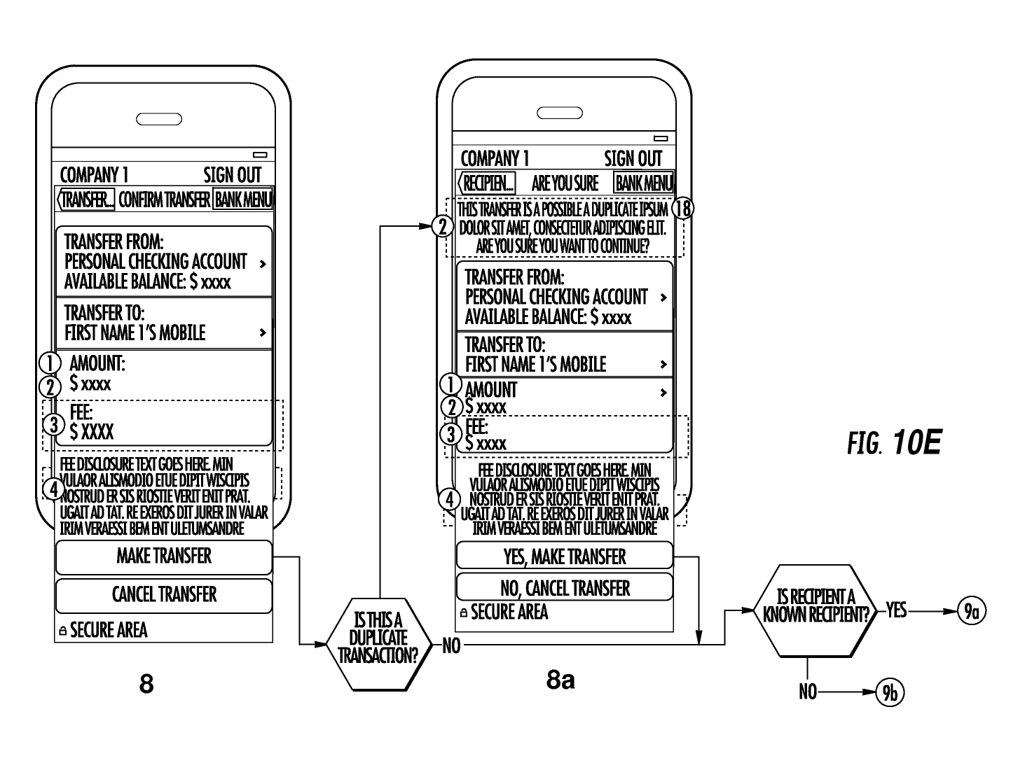

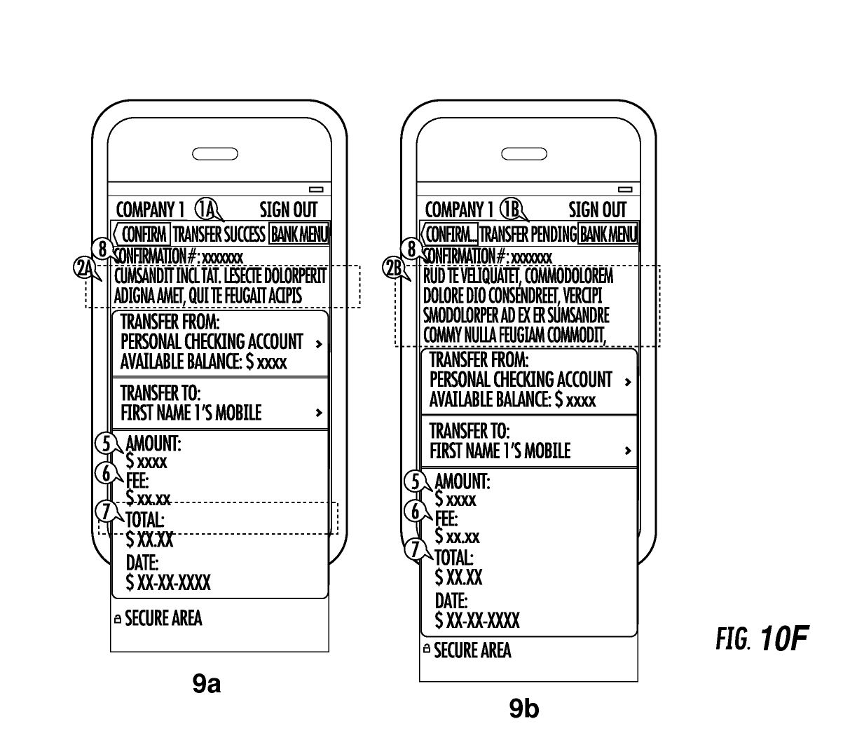

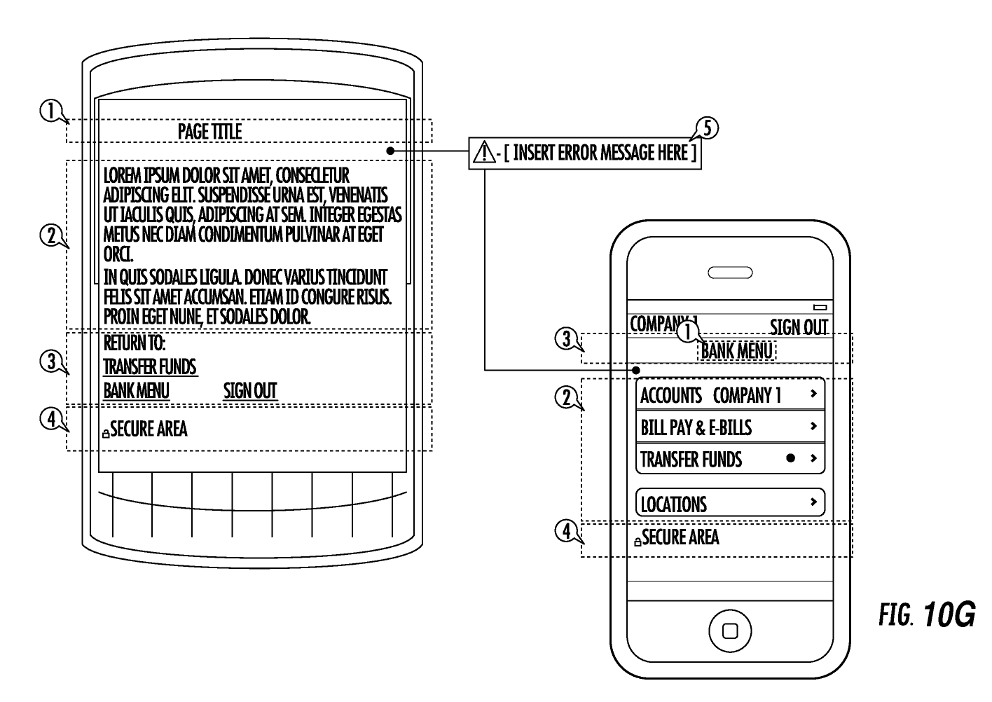

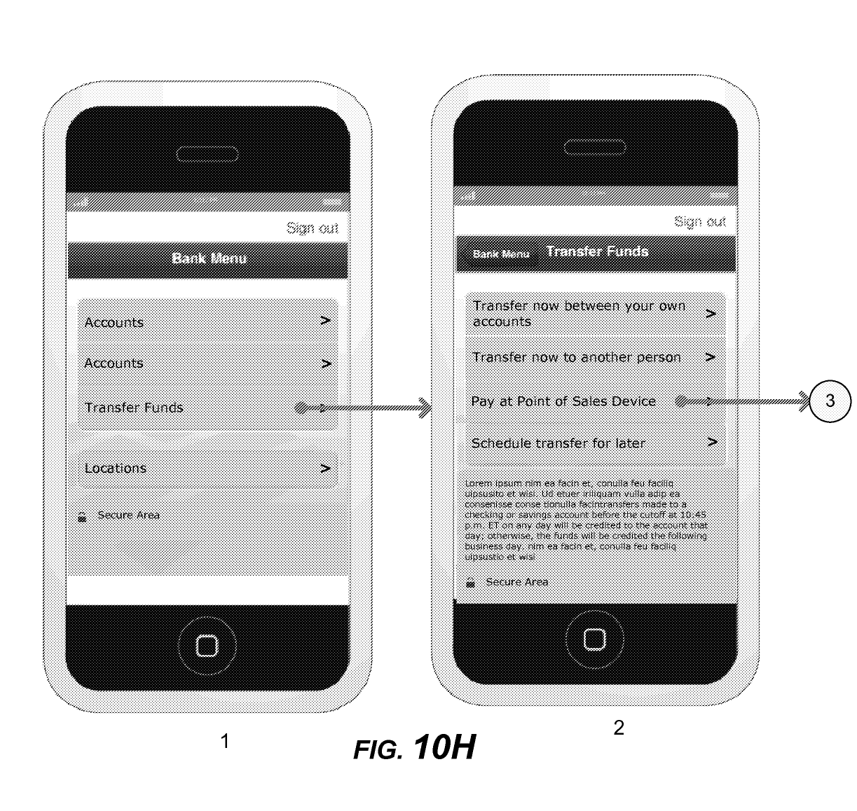

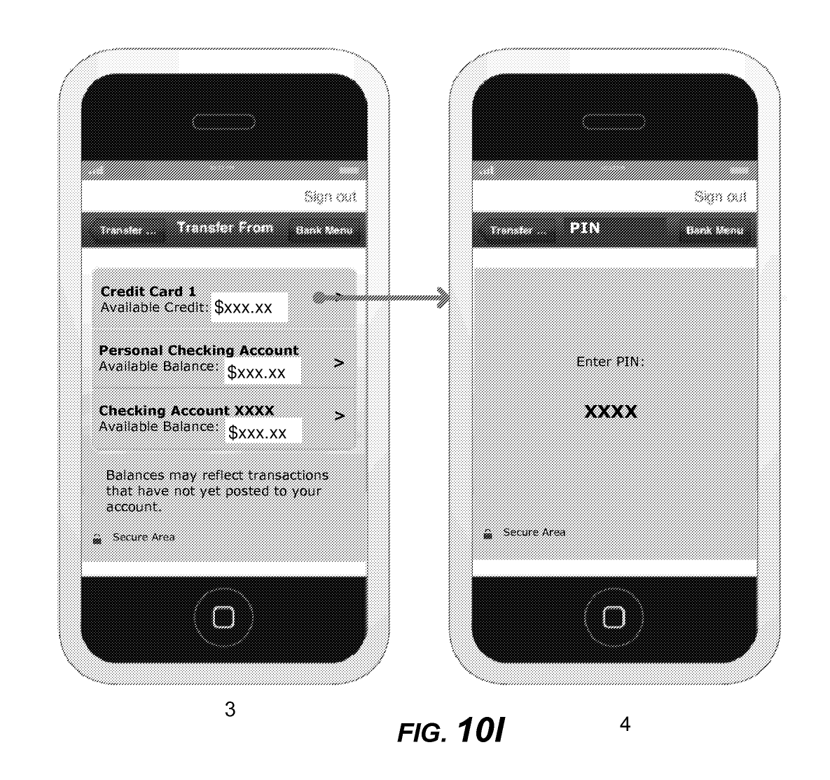

The process then moves to block 925 of FIG. 9A where the mobile P2P payment system client application 794 provides a mobile banking menu including an option to transfer funds. A screenshot is illustrated in FIG. 10A(1). As shown in FIG. 10A(1), the mobile P2P payment system client application 794 displays a bank menu page on which the first user can navigate to an accounts function, a bill-paying function, a transfer funds function, or a location function. Further, the mobile P2P payment system client application 794 indicates to the first user that the first user is in a secure area of the mobile banking system 700. The bank menu page also has a text area where error messages are displayed. The mobile P2P payment system client application 794 always allows users to sign out from their accounts on any mobile webpage by providing an appropriate hyperlink or button.

The process then moves to block 930 of FIG. 9B where the first user 410 selects the transfer funds option from the menu displayed in FIG. 10A(1).

The process then moves to block 932 of FIG. 9B where the mobile P2P payment system client application 794 provides a transfer funds menu that includes an option to transfer to another person. This can be seen in FIG. 10A(2), where based on the user activating the transfer funds function on the screenshot of FIG. 10A(1), the mobile P2P payment system client application 794 displays three options for the first user including an option to transfer between the first user's own accounts, an option to transfer to another person, and an option to schedule a transfer for later execution. In one embodiment, each of these three options is a hyperlink that is linked to mobile payment system 700. The mobile P2P payment system client application 794 indicates to the first user using a static textbox that any transfers made to an account before a cutoff time on any day will be credited to that account; otherwise the transfer will credited on the following business day.

The process then moves to block 934 of FIG. 9B where the first user 410 selects the option to transfer to another person from the transfer funds menu.

The process then moves to block 936 of FIG. 9B where the mobile banking system 700 provides eligible financial institution accounts and their balances to the mobile P2P payment system client application 794.

The process then moves to block 938 of FIG. 9B where the mobile P2P payment system client application 794 displays a list of eligible financial institution accounts that can participate in the mobile P2P transfer as well as their associated balances. A relevant screenshot is shown in FIG. 10B(3) where the mobile P2P payment system client application 794 displays the eligible accounts and their balances. The mobile P2P payment system client application 794 also indicates to the first user that the balances may reflect transactions that have not yet been posted to the first user's account. In the illustrated example of FIG. 10B(3), a personal checking account, a regular savings account and another checking account and their respective balances are depicted.

The process then moves to block 940 of FIG. 9B where the first user 410 can select an account to transfer funds from.

The process then moves to block 942 of FIG. 9B where the mobile banking system 700 provides any of first user's saved P2P transfer recipients to the mobile P2P payment system client application 794.

The process then moves to block 944 of FIG. 9B where the mobile P2P payment system client application 794 displays a list of any saved P2P transfer-to accounts or recipients and an option to add a new recipient. A screenshot of this list is shown in FIG. 10B(4) where any saved P2P transfer recipients are visible in the region displayed as “Account Nickname 1” and “Account Nickname 2.” Activating any particular transfer-to account that is in the name of or otherwise associated with the first user will take the first user to an account details page for that particular account. Activating any particular transfer-to account not in the name of or associated with by the first user (i.e., another user's account) will not take the first user to an account details page for that particular account. In one embodiment, the first user cannot see the balance of a transfer-to account not in the name of or associated with the first user. FIG. 10B(4) also displays a hyperlink to add a new transfer recipient. This link is only available if the first user has agreed to the terms and conditions page on the first user's mobile banking account. In one embodiment, the mobile P2P payment system client application 794 can only display a first pre-determined number of transfer-to accounts or recipients per page. Therefore as shown in FIG. 10B(4a), if the number of transfer-to accounts are greater than a first pre-determined number, then a first user has to activate the next button to choose other recipients if the user wants to choose a recipient who is not in the initial pre-determined displayed list of recipients. If the number of transfer-to accounts or recipients are greater than a second higher pre-determined number, then as shown in FIG. 10B(4b), the mobile P2P payment system client application 794 provides the first user with the next button and the previous button to navigate between groups of recipients. If the number of transfer-to accounts or recipients is greater than a first pre-determined number but smaller than a second higher pre-determined number, then the mobile P2P payment system client application 794 provides the first user with a previous button but not a next button. In one embodiment of the invention, the first pre-determined number is 10 and the second higher pre-determined number is 20.

The process then moves to block 946 of FIG. 9B where the first user 410 can select a recipient from the list to participate in the P2P transfer by activating the link associated with a particular recipient. If the user selects an existing recipient, then the mobile P2P payment system client application 794 presents to the user the transfer GUI of block 960 (FIG. 9C) that is described later. Alternatively, the process can move to block 948 of FIG. 9B where the first user adds a new recipient by activating the link to add a new recipient. In one embodiment, in which the user is limited to adding a predetermined number of new recipients in a daily period, if the first user has reached the pre-determined daily recipient limit, the mobile P2P payment system client application 794 displays an error message on an area of the mobile webpage displayed in FIG. 10B(4).

The process then moves to block 950 of FIG. 9C where the mobile P2P payment system client application 794 presents to the first user a GUI to add a new recipient. A screenshot of this GUI is shown in FIG. 9C. As shown in FIG. 10C(5), the mobile P2P payment system client application 794 presents an input field to enter the recipient's first name, an input field to enter the recipient's last name, an input field to enter a nickname associated with the recipient as chosen by the first user, a first input field to enter an alias, and a second input field to re-enter the alias which is checked against the alias entered into the first input field to verify that both aliases match. In one embodiment, the alias can be, but is not limited to, a mobile device number or an email address. The GUI also presents the user with a button to add the new recipient. The process then moves to block 952 of FIG. 9C where the first user enters the new recipient's first name, last name, nickname, and alias, along with re-entering the alias and activating the button the add the recipient. As shown in FIG. 10C(6), a pre-confirmation page is now displayed where the mobile P2P payment system client application 794 asks the first user to confirm the details of the recipient by activating the confirm button. In one embodiment, the complete set of characters comprising the alias is not displayed on the pre-confirmation page. By activating any of the entries entered by the first user, the first user can be taken back to the mobile webpage for adding recipient details. For instance, if the first user activates the first name that is displayed on the pre-confirmation page, a hyperlink embedded into the text allows the first user to return to the pre-confirmation page FIG. 10C(5) for editing the first name.

Once the first user activates the confirm button, the process moves to block 954 of FIG. 9C where the mobile P2P payment system client application 794 locally stores the new recipient's information in the first user's list of P2P transfer recipients and/or communicated to the mobile banking system 700.

The process then moves to block 956 of FIG. 9C where the mobile banking system 700 stores the new recipient's information in the first user's list of P2P transfer recipients.

The process then moves to block 960 of FIG. 9C where the mobile P2P payment system client application 794 presents a transfer GUI showing selected account and selected/new recipient, and prompting the first user to enter a transfer amount. This is shown in FIG. 9D where the screenshot shows that on a transfer details page, the mobile P2P payment system client application 794 displays the transfer-from account, the transfer-to account or recipient alias, and an input text box for entering the amount that the first user 410 wishes to transfer. As shown in FIG. 9D, the GUI also presents disclosure text regarding any possible fees that will be incurred by the first user for making this transfer. The GUI also displays a submit button for submitting the transfer and a cancel button for canceling the transfer and returning to the menu page shown in FIG. 9A.

The process then moves to block 962 of FIG. 9C where the mobile banking system 700 determines if the selected recipient is associated with an alias or a financial institution account number.

If, in block 962 of FIG. 9C, the mobile banking system 700 determines that the selected recipient is associated with an alias, then the process moves to block 964 where the mobile banking system 700 adds the transfer cost assessment and shows this transfer cost assessment in a GUI. If, in block 962 of FIG. 9C, the mobile banking system 700 determines that the selected recipient is not associated with an alias, then the process moves to block 966 where the mobile banking system 700 does not show or add a transfer cost assessment. As stated above and as shown in FIG. 10D, the mobile P2P payment system client application 794 displays any possible transfer cost assessment disclosure (along with the transfer cost assessment in some embodiments) in a text box. In one embodiment, this cost assessment disclosure text box is placed under the text input field where the first user enters the amount to be transferred.

The process then moves to block 968 of FIG. 9C where the first user enters a transfer amount in the appropriate text input field as shown in FIG. 10D.

The process then moves to block 970 of FIG. 9D where the mobile P2P payment system client application 794 communicates the amount to be transferred to the mobile banking system 700.

The process then moves to block 972 of FIG. 9D where the mobile banking system 700 determines if the transfer amount is above a maximum limit placed on the transfer. In one embodiment, there is a pre-determined amount maximum placed on the first user (sender). In another embodiment, there is a pre-determined amount maximum placed on the recipient. In still another embodiment, both these pre-determined amount maximums place a ceiling on the amount that can be transferred via a mobile P2P transfer. There may be several factors that affect this limit including, but not limited to, the first user's identity, the recipient's identity, the length and nature of the first user's relationship with the financial institution, the length and nature of the recipient's relationship with the financial institution, the amount of funds that the first user has deposited at the financial institution, the first user's status with the financial institution, and the like. In one embodiment, the maximum amount that can be transferred using the mobile P2P transfer method is dynamically determined, at the time of the transfer request, by a supporting application that works in conjunction with or is embedded within the mobile P2P payment system client application 794.

If in block 972 of FIG. 9D the transfer amount is above the maximum allowable limit, then the mobile P2P payment system client application 794 displays an error message to the first user as represented by block 974.

If in block 972 of FIG. 9D the transfer amount is below or equal to the maximum allowable limit, the mobile P2P payment system client application 794 requests user confirmation of the transfer request as represented by block 976. A GUI that captures a screenshot of this pre-confirmation page is displayed in FIG. 10E(8). Here, the mobile P2P payment system client application 794 displays the transfer-from account, the transfer-to account or recipient alias, the amount to be transferred, and the cost assessment to be incurred by the first user for making this transfer. The GUI also displays cost assessment disclosure text on the page. In some embodiments, there is no cost assessment incurred by the first user for making the transfer. As shown in FIG. 10E(8), the GUI also displays two buttons or hyperlinks, one for making the transfer and one for canceling the transfer and returning to the bank menu page shown in FIG. 10A.

The process then moves to block 978 of FIG. 9D where the first user confirms the transaction request by activating the button or hyperlink for making the transfer. If the mobile banking system 700 recognizes that this transaction is a duplicate of another transaction executed within a pre-determined amount of time in the past, then, as shown in FIG. 10E(8a), the mobile P2P payment system client application 794 displays another pre-confirmation page informing the first user that the transfer is a possible duplicate of a recently executed transaction. As shown in FIG. 10E(8a), the GUI also displays two buttons or hyperlinks, one for making the transfer and one for canceling the transfer and returning to the bank menu page shown in FIG. 10A.

The process then moves to block 980 of FIG. 9D where the mobile banking system 700 determines whether the recipient is associated with an alias or a financial institution account number. If the recipient is associated with a financial institution account number, the process moves to block 981 where the mobile banking system 700 uses the financial institution account number to initiate an Automated Clearing House (ACH) transfer or other type of transfer. Subsequently, the process moves to block 982 of FIG. 9D where the mobile P2P payment system client application 700 provides notification to the first user that a transfer or a notice of transfer request to the recipient (second user) has been initiated and displays the information regarding the transfer to the first user. An instance of this notification is shown in FIG. 10G. FIG. 10G shows a confirmation page that displays the transfer-from account, the transfer-to account or recipient alias, the amount transferred, the cost assessment incurred by the first user for making this transfer, the total cost of the transfer, and the date on which the transfer was executed. The confirmation page also displays a confirmation number associated with the transfer.

If, in block 980, the recipient is associated with an alias then, the process moves to block 983 where the mobile banking system 700 sends the alias and the recipient's name to an alias data repository 800.

The process then moves to block 984 where the alias data repository 800 looks up the alias in an alias datastore. Then the process moves to block 985, where the alias data repository 800 determines whether the alias is associated with a financial institution account. If the alias is associated with a financial institution account, then, if the alias data repository 800 determines that the provided name matches the name in the datastore, then the process moves to block 981 of FIG. 9D where the mobile banking system 700 uses the financial institution account number to initiate the ACH transfer or other type of transfer. Subsequently, the process moves to block 982 of FIG. 9D where the mobile P2P payment system client application 794 provides notification to the first user that a transfer or a notice of transfer request to the recipient (second user) has been initiated and displays the information regarding the transfer to the first user. An instance of this notification is shown in FIG. 10F. FIG. 10F shows a confirmation page that displays the transfer-from account, the transfer-to account or recipient alias, the amount transferred, the cost assessment incurred by the first user for making this transfer, the total cost of the transfer, and the date on which the transfer was executed. The confirmation page also displays a confirmation number associated with the transfer. The confirmation page also displays whether the transfer has been successful FIG. 10F(9a) or whether it is still pending FIG. 10F(9b).

If in block 985 of FIG. 9D, the alias data repository 800 determines that the alias is not associated with a financial institution account, then the process moves to block 988 where the mobile P2P payment system client application 794 displays information about the transfer to the first user and indicates that the transfer is pending.

The process then moves to block 990 of FIG. 9E where the mobile banking system determines whether if the recipient (second user) has an eligible financial institution account. If the recipient (second user) does not have an eligible financial institution account, then in block 992, the mobile banking system 700 uses an alias to send the recipient notification of requested transfer from the first user and an offer to open a financial institution account with the financial institution that manages the mobile banking system 700. In one embodiment, the alias is a phone number or an email address.

The process then moves on from block 992 to block 993 of FIG. 9E, where if the second user decides to not open a financial institution account at the financial institution that manages the mobile banking system 700, then the mobile banking system 700 cancels the transfer and notifies the first user in block 999.

If in block 993 of FIG. 9D, the second user (recipient) decides to open a new financial institution account, the mobile banking system 700, in block 995, opens a new account for the second user. Subsequently, the second user (recipient) must determine in block 994 whether the second user registers the new financial institution account for the mobile P2P service.

As shown in FIG. 9E, if the second user in block 994 does not register the new financial institution account opened in block 995, then the mobile banking system 700 cancels the transfer and notifies the first user in block 999.

As shown in FIG. 9E, if the second user registers the new financial institution account in block 994 for mobile P2P transfers, then the mobile banking system 700, in block 996, uses the new registered financial institution account to initiate an ACH transfer or other type of transfer. The process then moves to block 997 where the mobile banking system 700 sends the alias and the new registered account information to the alias data repository 700. The process then moves to block 998 of FIG. 9E where the alias data repository 700 stores recipient's alias in alias datastore along with recipient's (second user's) new registered financial institution account.

If the recipient (second user) has an eligible financial institution account as determined by the mobile banking system 700 in block 990, then the process moves to block 991 in FIG. 9E where the mobile banking system 700 uses an alias (e.g., phone number or email address) to send recipient (second user) notification of requested transfer, and offers to register the recipient's financial institution account and alias. As shown in FIG. 9E, then the process moves to block 994 where if the second user (recipient) decides not to register the second user's financial institution account for mobile P2P transfers, then the mobile banking system 700 cancels the transfer and notifies the first user.

As shown in FIG. 9E, if the second user (recipient) registers the eligible financial institution account in block 994, then the mobile banking system 700 uses the eligible registered financial institution account to initiate an ACH transfer or other type of transfer in block 996. The process then proceeds to block 997 where the mobile banking system 700 sends alias and the eligible registered account information to the alias data repository 800. The process then moves to block 998 of FIG. 9E where the alias data repository 800 stores recipient's alias in alias datastore along with recipient's eligible registered financial institution account.

Referring now to FIG. 9F, the method 900 is further illustrated. In block 9005 the mobile P2P payment system client application 794 provides a “Transfer Funds” menu including a “Pay at POS” option. This can be seen in FIG. 10H(2) where based on the user activating the transfer funds function on the screenshot of FIGS. 10H(1), the mobile P2P payment system client application 794 displays four options including an option to pay at a point of sales device, among others. In one embodiment, each of the four options is a hyperlink that is linked to the mobile banking system 700. It will be understood that the point of sales may be associated with a physical location such as a fuel pump or cash register, and/or an internet or wireless communication.

The process then moves to block 9010 where the first user 410 selects the option to pay at a point of sales device from the transfer funds menu. Further in block 9010, the first user 410 selects a payment account. FIG. 101(3) shows a screenshot of a transfer from menu, where a user selects an account.

The process then moves to block 9015 where the mobile banking system 700 generates a random number (e.g., a PIN) associated with the payment account.

The process then moves to block 9020 where the client application 794 displays the random number. In FIG. 1044), a PIN menu is shown in the screenshot. The user is instructed to enter the PIN at the point of sales device when checking out as shown in FIG. 101(4).

The process then moves to block 9025 where the first user inputs the random number in a point of sales device.

The process then moves to block 9030 where the mobile banking system 700 identifies the recipient (i.e., the second user) and a payment amount. The mobile banking system 700 then determines if the payment account is an eligible account in block 9035. If the payment account is not an eligible account, the payment amount is forwarded to a third party financial institution 470 in block 9040. If the payment account is an eligible account, the payment amount is transferred to the recipient (i.e., the second user) as shown in block 9045. In block 9050, the second user receives a payment amount confirmation.

Although FIGS. 9A-9F illustrated a process using a mobile device, it will be understood that process may include other computing devices. For example, in some embodiments, an internet connected device such as a lap top, personal computer, or tablet includes a microchip or other circuitry. The microchip may be embedded in a lap top such that the lap top can communicate with an application on a mobile device. For example, near field communication or other wireless technology may be used to communicate with a nearby application on a smart phone to enable a P2P or P2M transaction for an online purchases or payment.

### Online Banking Alias Registration and P2P Payment Receive Process and Interface

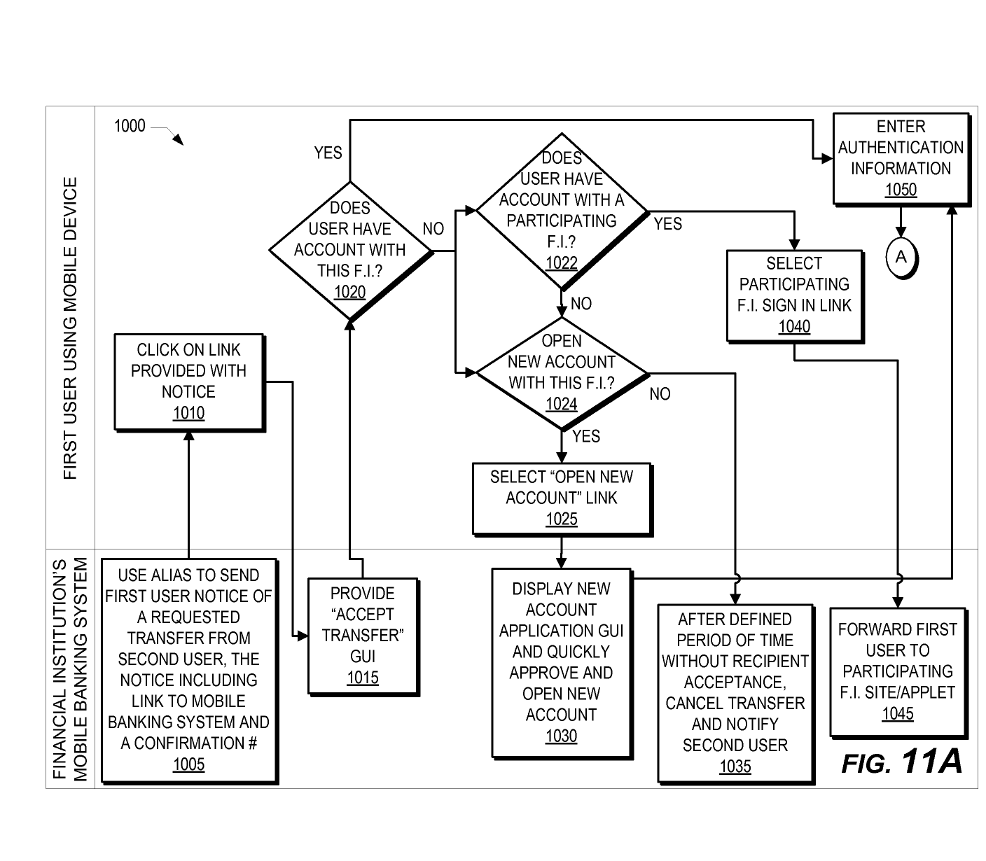

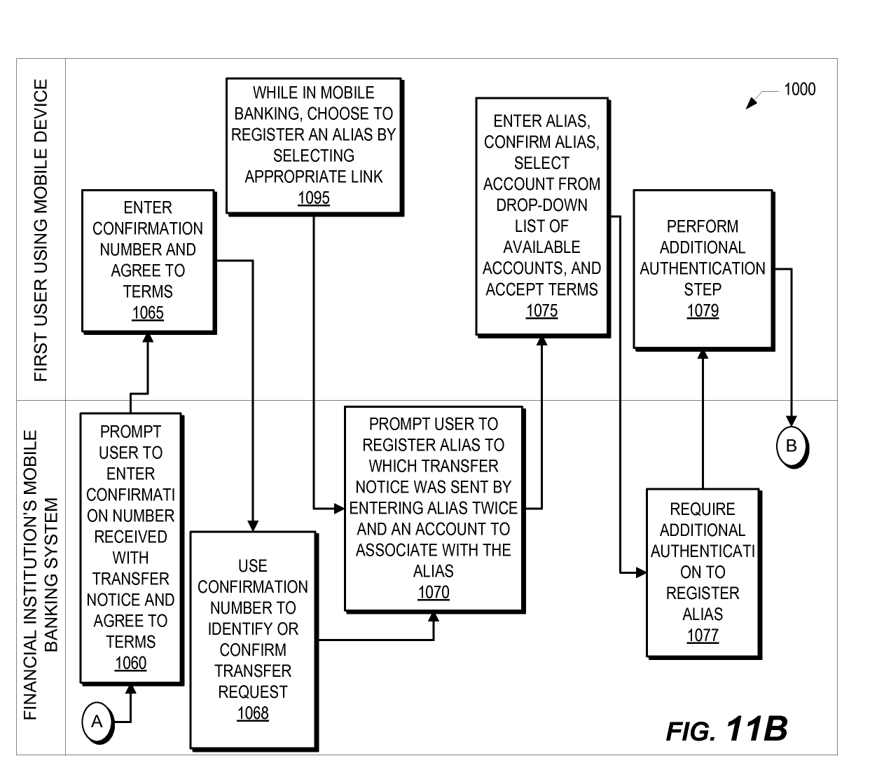

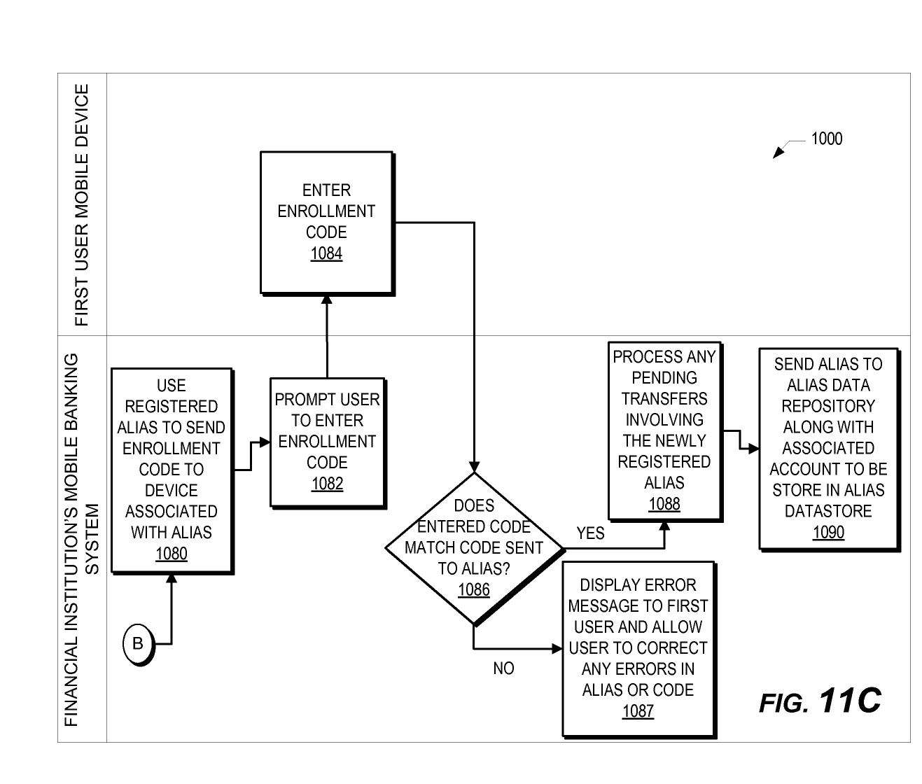

FIGS. 11A-11C provide flow charts illustrating a process 1000 for receiving P2P payments, in accordance with an embodiment of the invention. FIGS. 11A-11C illustrate the flow chart in terms of “swim lanes” associated with entities which may perform the operations in each respective swim lane. The entities illustrated in the exemplary Figures are a financial institution's mobile banking system 700 and a first user (recipient) using a first personal computing or mobile device. However, it should be noted that other entities could also be involved and some embodiments of the invention may not be limited to the two entities illustrated in FIGS. 11A-11C. Additionally, it should be understood that, in other embodiments of the invention, the entities need not be required to perform the actions illustrated in each respective swim lane. For example, some of the process steps described herein may be performed by the first entity (or other entities) even though the element may be illustrated as in the swim lane of the second entity. Similarly, in some embodiments, some of the process steps may be performed by the second entity (or other entities) even though the element may be illustrated as in the swim lane of the first entity.

The process 1000 in FIG. 11A starts with block 1005 where a mobile banking system 700 sends a first user (recipient) notice of a requested transfer from a second user, the notice including a link to the mobile banking system 700 and a confirmation number.

The process then proceeds to block 1010 where a first user (recipient) activates the link provided with the notice. In block 1015 the mobile banking system 700 provides an “Accept Transfer” GUI.

The mobile banking system 700 alerts the first user (recipient) that to accept the transfer, the first user will need an eligible checking or saving account at a participating financial institution. For customers who hold accounts at the financial institution that manages the mobile banking system 700, the mobile banking system 700 presents a widget with a textbox that allows the first user to enter login or other authenticating information. The mobile banking system 700 also provides a link for the first user to enroll with the financial institution's mobile banking system. For customers of other participating financial institutions, the mobile banking system 700 provides a sign-in button, which might either display a sign-in widget on the instant page or might provide for a link to another page where the first user can enter login information for the participating financial institution. The mobile banking system 700 also notifies the first user that if the first user does not have an account with one of the participating banks, that first user can open an account at the financial institution that maintains the mobile banking system 700. The mobile banking system 700 notifies the first user that he or she may review the terms of opening a new account at this financial institution, including any fees that may be incurred by the first user in opening this new account. The mobile banking system 700 also notifies the first user that if the first user does not want to open a new financial institution account, the first user may notify the sender to arrange an alternate transfer method. The mobile banking system 700 also notifies the first user that the transaction will be canceled if it is not accepted within a predetermined period of time.

The process then proceeds to block 1020 of FIG. 11A where the first user (recipient) determines whether the first user has an account with the financial institution that manages the mobile banking system 700. If the first user has a financial institution account with the financial institution that manages the mobile banking system 700, then the process moves to block 1050 where the first user enters authentication information into the appropriate textbox.

As shown in FIG. 11A, if the first user does not have a financial institution account with the financial institution that manages the mobile banking system 700 then the process proceeds to block 1022 where the first user determines whether the first user has an account with participating financial banks or financial institutions. If the first user has a financial institution account with a participating financial institution, the process proceeds to block 1040 where the first user can select the participating financial institution sign-in link. The process then moves to block 1045 where the mobile banking system 700 forwards the first user to a participating financial institution's website or alternatively, the mobile banking system 700 opens a widget or an applet on the same window or new pop-up window.

As shown in FIG. 11A, if, in block 1020, the first user does not have an account the financial institution that manages the mobile banking system 700 and if, in block 1024, the first user (recipient) does not open a new account with the financial institution that manages the mobile banking system 700, then, as shown in block 1035, after a defined period of time without recipient (first user) acceptance, the mobile banking system 700 cancels the transfer and notifies the second user (sender). In other embodiments, the transfer is sent to a third party financial institution for processing.

As shown in FIG. 11A if, in block 1024, the first user opens a new account with the financial institution that manages the mobile banking system 700, then the first user, in block 1025, selects the link directing the first user to open a new account with the financial institution that manages the mobile banking system 700.

As shown in FIG. 11A, the link in block 1025 directs the mobile banking system 700 to display a new account application GUI to the first user (see block 1030), which new account application quickly approves and opens a new account for the first user after receiving any pertinent information that may be required to open and be approved for a new account at the financial institution that manages the mobile banking system 700. The process then proceeds to block 1050 in FIG. 11A where the first user enters authentication information into a textbox.

The process then moves to block 1060 in FIG. 11B where the mobile banking system 700 prompts the first user to enter a confirmation number received with the transfer notice and agree to the terms governing the transfer as shown in block 1060. The mobile banking system 700 indicates to the first user that this is the start of the procedure to accept a transfer to money to the first user's email address or mobile number. The mobile banking system 700 prompts the first user to enter the received confirmation number in a textbox. The webpage also has two buttons—a first button configured to allow the first user to indicate a desire not to proceed with accepting the transfer and a second button configured to allow the first user to indicate a desire to proceed with the transfer. The second button can move from a dormant state to an activatable state by checking the check-box to confirm that the first user has a) has read and agrees to the terms of the service agreement, including the terms of the Email/Mobile Network Transfer section; b) consents to receive email and automated text messages about Email/Mobile Transfers; c) will only register mobile numbers where the first user is the account holder; or if the first user is not the account holder, he or she has the account holder's permission to register that mobile number; and d) will obtain the consent of the person to whom he or she wants to send a Mobile Transfer text message to receive the automated text message. In one embodiment, the first user has to always go through the procedure of accepting the transfer. In other embodiments, the first user does not have to go through the procedure accepting the transfer for any transfer after the first transfer.

Subsequently, in block 1065, the first user enters a confirmation number in the appropriate textbox and agrees to the terms that govern the transaction by activating the appropriate checkbox. The first user then activates on the second button to continue the process of accepting the transfer.

The process then moves to block 1068 of FIG. 11B where the mobile banking system 700 uses the confirmation number entered in block 1065 to identify or confirm the transfer request.

Then the process proceeds to block 1070 of FIG. 11B where the mobile banking system 700 prompts the user to register the alias to which the transfer notice was sent. The user while in mobile banking chooses to register an alias by selecting an appropriate link as indicated by 1095. The mobile banking system 700 indicates to the first user that if the first user has received a notice that money was sent to the first user, then the first user will need to set up to accept transfers the same email address or mobile number that received the transfer notice. The page shows a first textbox where the user can enter the alias that received the transfer notice, and a second textbox where the user can confirm the alias entered in the first textbox by re-entering the alias in the second textbox. The mobile banking system 700 also prompts the user to select the appropriate account to link to the alias that will receive the funds by selecting the appropriate account from a drop down list. The mobile banking system 700 also prompts the user to check a checkbox, whereby the first user by checking the checkbox agrees that by registering the alias, he or she is the alias account holder, or has the alias account holder's permission to register it, and consents to receive email and text messages about alias transfers at this email address or phone number. In some embodiments, the mobile banking system 700 presents an authentication widget that will be described in further detail below. The page also has two buttons—a first button configured to allow the first user to indicate a desire not to proceed with receiving the transfer and a second button configured to allow the first user to indicate a desire to proceed with receiving the transfer. This second button moves from a dormant state to an activatable state after the first user enters all the required information on the page and has been further authenticated, as in some embodiments. In one embodiment, the mobile banking system 700 also saves the information entered on this page, so that the first user does not have to re-register an alias every time the first user receives a P2P money transfer.

The process then proceeds to block 1075 where the first user enters the alias in the appropriate textbox, confirms the alias in the appropriate textbox, selects the account to receive the funds from the drop-down list, and checks the checkbox that indicates that the first user accepts the terms that govern the transfer. In some embodiments, the accounts listed in the drop-down list are identified only by selected few digits of the account numbers.

In some embodiments, the process then proceeds to block 1077 where the mobile banking system 700 requires additional authentication to register an alias. The mobile banking system 700 displays a widget which serves as an additional authenticating step before saving the information of the first user's associated alias. The mobile banking system 700 indicates to the first user that by activating in the widget on the button for a sending a code, the first user will receive a code on his or her mobile device. In another embodiment, the first user may receive a code through other means such as email, snail mail, and the like. In one embodiment, the widget is a widget and the user can send a security code to the first user's mobile device.

The process then moves to block 1079 of FIG. 11B where the first user performs an additional authenticating step. The first user activates on the widget's button for sending a code to the first user's mobile device. The first user than receives on his or her mobile device the code that he or she must input into the widget. Once the first user inputs the correct code into the widget and presses a button in the widget to confirm that the code is correct, the button that corresponds to adding a new recipient is activated so that it can now be activated by the first user. The first user (recipient) activates this button so that the mobile banking system 700 can store the first user's alias. The first user can activate a designated button on the page which indicates that the first user wishes to proceed with receiving the transfer. The mobile banking system 700 indicates to the first user that by activating the button to continue with receiving the transfer, the first user will receive an enrollment code.

The process then moves to block 1080 of FIG. 11C where the mobile banking system 700 uses the registered alias to send an enrollment code to the device of the first user (recipient) associated with the alias.

The process then moves to block 1082 of FIG. 11C where the mobile banking system 700 prompts the first user to enter the enrollment code that the first user received on the device associated with the alias. The mobile banking system 700 indicates to the first user that the first user must verify the alias (e.g., mobile number) to complete enrollment in the mobile P2P transfer service. In one embodiment, the webpage indicates to the first user that the first user should expect a text message from the financial institution that manages the mobile banking system 700. The page also has activatable text if the first user would like to know more about the use of enrollment codes. The page indicates to the first user, the enrollment code must be entered into the appropriate textbook in order verify ownership of the mobile number or email address associated with the alias and complete enrollment with the P2P transfer service. The mobile banking system 700 also indicates to the first user that the enrollment number expires in a pre-determined number of minutes. After the enrollment number expires, the mobile banking system 700 will not be able use that enrollment code to verify ownership of the first user's mobile number associated with the transfer and will not be able to complete the enrollment of the first user (recipient). The webpage also has activatable text to get help if the first user has not received an enrollment code or if the enrollment code has expired. The page indicates to the first user that messaging and data rates may apply for receiving the enrollment code. The page also has two buttons—a first button configured to allow the first user to indicate a desire not to proceed with the transaction and a second button configured to allow the first user to indicate a desire to proceed with receiving the transfer. The second button only moves from a dormant state to an activatable state after the first user enters an enrollment code on the page. In an embodiment, the second button only becomes activatable after the first user enters a valid and unexpired enrollment code on the page.

The process then moves to block 1084 where the first user enters the enrollment code into the appropriate textbox.

The process then moves to block 1086 where the mobile banking system 700 determines if the enrollment code entered by the first user matches the enrollment code sent by the mobile banking system 700 to the alias of the first user.

If the entered code in 1086 does not match the code sent to the alias, then the mobile banking system 700 displays a graceful error message to the first user that the transaction cannot move any further. In one embodiment, the mobile banking system 700 allows the first user to correct any errors in the alias provided by the first user or in the code received by the first user as shown in 1087. In one embodiment, the mobile banking system 700 only grants a predetermined number of unsuccessful attempts to verify the code before rejecting the transfer.

If the entered code in 1086 matches the code sent to the alias, the process moves to block 1088 where the mobile banking system 700 processes any pending transfers involving the newly registered alias. The mobile banking system 700 indicates to the user that the verification of the alias has been completed. The mobile banking system 700 thanks the user for setting up an alias to accept transfers. The mobile banking system 700 indicates to the first user that people or entities can now send money to the first user using the first user's alias. The mobile banking system 700 indicates to the first user that any transfer to the first user's newly registered alias will be deposited to the account number shown on the webpage. In one embodiment, the mobile banking system 700 only shows a selected few digits of the first user's financial institution account number. The page also indicates to the first user that the transfer request is now in process. The page shows details of the transfer, including, but not limited to the name of the sender, the amount, the date on which the sender sent the amount, the confirmation number, and the status of the transfer. The page also two buttons. The first button allows the first user to add another alias and the second button allows the first user make a transfer using the newly registered alias.

The process then moves to block 1090 where the mobile banking system 700 sends the alias to the alias data repository 800 along with associated account information to be stored in the alias datastore.

In one embodiment, the mobile banking system 700 presents four hyperlinks under the transfers hyperlink described earlier. These four hyperlinks are a hyperlink for a making a transfer, a hyperlink for reviewing transfers, a hyperlink for adding recipients, and a hyperlink for managing accounts. Using the appropriate hyperlink, the first user has the option of obtaining set up to accept transfer by activating an appropriate link. The mobile banking system 700 indicates to the first user (recipient) that the first user may activate the link if the first user received a transfer notice, i.e., the first user received an email, text message, or other form of electronic communication that someone has sent money to the first user. The mobile banking system 700 indicates to the first user that in order to complete the transfer and collect the funds, the first user must set up the first user's alias to accept transfers. The mobile banking system 700 also presents an activatable link so that the first user can be directed to a page to learn more about this P2P transfer via alias method. The mobile banking system 700 also presents a help box where the first user can understand more about what the first user can do using the mobile banking system 700, what the first user needs to know, and what else the first user can do using the mobile banking system 700. The mobile banking system 700 also presents a message to the first user that transferring money within the bank is fast and free. The mobile banking system 700 also indicates to the customer that the feature of making a P2P transfer using a recipient's alias is a new feature, and that transfers within the bank now include transfers made using a recipient's alias. Alternatively, a user who intends to receive money using an alias can get set up by activating the link associated with obtaining a set up to accept transfers. A user who accesses the mobile banking system 700 can register an alias by selecting an appropriate link. Therefore, in one embodiment, the user does not have to wait to receive a payment using the mobile P2P transfer service before setting up an alias to receive transfers. In one embodiment, the user can register an alias using a mobile device, while in another embodiment, the user can register an alias using a personal computing device.

In one embodiment of the invention, both the sender and the recipient need to have financial institution accounts registered for mobile P2P transfer via alias. In another embodiment of the invention, the sender needs to have a financial institution account registered for mobile P2P transfer via alias, but the recipient does not need to have a financial institution account registered for mobile P2P transfer via alias. In another embodiment of the invention, the recipient needs to have a financial institution account registered for mobile P2P transfer via alias, but the sender does not need to have a financial institution account registered for mobile P2P transfer via alias.

In one embodiment of the invention, both the sender and the recipient need to have financial institution accounts registered for P2P transfer via alias. In another embodiment of the invention, the sender needs to have a financial institution account registered for P2P transfer via alias, but the recipient does not need to have a financial institution account registered for P2P transfer via alias. In another embodiment of the invention, the recipient needs to have a financial institution account registered for P2P transfer via alias, but the sender does not need to have a financial institution account registered for P2P transfer via alias.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A method for conducting financial transactions, the method comprising:
receiving, via a computing device, financial transaction instructions, wherein the financial transaction instructions comprise a first alias and a second alias;
associating, via a computing device processor, the first alias with at least one payment account, and the second alias with at least one recipient account; and
communicating, via a computing device, a financial transaction notification to a recipient associated with the at least one recipient account.

2. The method of claim 1, wherein the first alias is associated with a user.

3. The method of claim 1, wherein the second alias is associated with a point of sales device.

4. The method of claim 1, wherein the first alias comprises a number associated with a mobile device, the number comprising a random number.

5. The method of claim 4, wherein the number is associated with an account.

6. The method of claim 4, wherein the number is associated with a financial institution.

7. The method of claim 1, wherein the first alias comprises a plurality of aliases associated with the at least one payment account.

8. The method of claim 7, wherein the plurality of aliases comprises a personal identification number.

9. The method of claim 1, further comprising:
determining that the at least one payment account is associated with a third party; and
forwarding a transaction notification to the third party.

10. The method of claim 1, further comprising:
receiving a payment amount from a user; and
transferring the payment amount to the at least one recipient account.

11. The method of claim 10, further comprising:
transferring a first portion of the payment amount to a first recipient account; and
transferring a second portion of the payment amount to a second recipient account.

12. The method of claim 1, further comprising:
monitoring financial transactions associated with a user; and
presenting a transaction history to the user.

13. The method of claim 12, further comprising:
determining a time period associated with the financial transactions; and
grouping the financial transactions into categories based on the time period.

14. The method of claim 2, further comprising:
identifying a loyalty card associated with the user;
determining rewards associated with the loyalty card; and
presenting the rewards to the user.

15. The method of claim 1, wherein the second alias comprises at least one identifier selected from the group consisting of: a mobile telephone number, an email address, a social networking ID, a name, an address, a URL address, a logo, a brand, a picture, graphical art, a trade name, a trade mark, a device, a loyalty card number, a merchant identifier, a textual indicator, a graphical indicator, a visual indicator, and combinations thereof

16. The method of claim 1, wherein the second alias comprises a plurality of aliases associated with the at least one recipient account.

17. The method of claim 1, wherein the at least one recipient account is associated with one or more financial institutions.

18. A computer program product, the computer program product comprising a computer-readable medium having computer-executable instructions for performing:
receiving financial transaction instructions, wherein the financial transaction instructions comprise a first alias and a second alias;
associating the first alias with at least one payment account, and the second alias with at least one recipient account; and
communicating a financial transaction notification to a recipient associated with the at least one recipient account.

19. The computer program product of claim 18, wherein the first alias is associated with a user.

20. The computer program product of claim 18, wherein the second alias is associated with a recipient.

21. The computer program product of claim 18, wherein the first alias comprises a number associated with a mobile device, wherein the number comprises a static number.

22. The computer program product of claim 18, wherein the first alias comprises a personal identification number.

23. The computer program product of claim 18, wherein the first alias comprises a plurality of aliases associated with the at least one payment accounts.

24. The computer program product of claim 18, wherein the second alias comprises a plurality of aliases associated with the at least one recipient account.

25. The computer program product of claim 18, wherein the financial transaction comprises one or more transactions selected from the group consisting of: payments, money transfers, purchases, gifts, credits, withdrawals, deposits, and combinations thereof.

26. The computer program product of claim 18, wherein the financial transaction instructions include a payment amount.

27. The computer program product of claim 26, wherein the computer-executable instructions further perform:
determining that the at least one recipient account is associated with a host financial institution;
transferring at least a portion of the payment amount to the recipient account.

28. The computer program product of claim 26, wherein computer-executable instructions further perform:
determining that the payment amount is above a threshold amount; and
automatically transferring the payment amount to the at least one recipient account based on the threshold amount.

29. The computer program product of claim 18, wherein computer-executable instructions further perform:
monitoring money transfers associated with a user;
identifying a merchant associated with the money transfers; and
grouping the money transfers into categories based on the merchant.

30. The computer program product of claim 18, wherein computer-executable instructions further perform:
identifying a loyalty card associated with a user;
determining rewards associated with the loyalty card; and
presenting the rewards to the user.

31. A system for conducting financial transactions, the system comprising:
a computer apparatus including a processor and a memory; and
a financial transaction software module stored in the memory, comprising executable instructions that when executed by the processor cause the processor to:
receive payment instructions, wherein the payment instructions comprise a first alias and a second alias;
associate the first alias with at least one payment account, and the second alias with at least one recipient account; and
communicate a payment notification to a recipient associated with the at least one recipient account.

32. The system of claim 31, wherein the first alias is associated with a user.

33. The system of claim 31, wherein the second alias is associated with a recipient.

34. The system of claim 31, wherein the first alias comprises at least one identifier selected from the group consisting of: a mobile telephone number, an email address, a social networking ID, a name, an address, a URL address, a logo, a brand, a picture, graphical art, a trade name, a trade mark, a device, a loyalty card number, a merchant identifier, a textual indicator, a graphical indicator, a visual indicator, and combinations thereof

35. The system of claim 35, wherein the computer-executable instructions further cause the processor to:
determine that the at least one recipient account is associated with an affiliated financial institution; and
transfer at least a portion of the payment amount to the at least one recipient account.

36. The system of claim 31, wherein the first alias comprises a plurality of aliases associated with the at least one payment account.

37. The system of claim 31, wherein the second aliases comprises a plurality of aliases associated with the at least on recipient account.

38. The system of claim 31, wherein the financial transaction notification comprises a payment amount.

39. The system of claim 31, wherein the computer-executable instructions further cause the processor to:
monitor the financial transactions associated with a user;
identify data based on the financial transaction, the data comprising information selected from the group consisting of: a time and date of the financial transactions, the identity of the purchased products, the identity of the merchant, the purchase amount, and combinations thereof; and
present a transaction history comprising the data to a user.

40. The system of claim 39, wherein the financial transaction comprises one or more transactions selected from the group consisting of: payments, money transfers, purchases, gifts, credits, withdrawals, deposits, and combinations thereof.
